(19) United States
(12) Patent Application Publication
(10) Pub. No.: US 2013/0282458 A1
(43) Pub. Date: Oct. 24, 2013

(54) SYSTEM AND METHOD FOR INCREASING CUSTOMER PARTICIPATION RATES ON ELECTRONIC SURVEYS RELATED TO A PARTICULAR COMMERCIAL TRANSACTION

(71) Applicants: Nathan Leon Roberts, Buford, GA (US); Joseph Andrew Vescio, Alpharetta, GA (US)

(72) Inventors: Nathan Leon Roberts, Buford, GA (US); Joseph Andrew Vescio, Alpharetta, GA (US)

(21) Appl. No.: 13/800,529

(22) Filed: Mar. 13, 2013

Related U.S. Application Data
(60) Provisional application No. 61/635,461, filed on Apr. 19, 2012.

(51) Int. Cl. G06Q 30/02

(52) U.S. Cl. CPC G06Q 30/0217
USPC 705/14.19

(57) ABSTRACT

A system and method for a vendor to provide and process a survey with a customer either before, at, or after a consumer transaction is described herein; wherein in one or more embodiments an incentive is offered and redeemable by the consumer contemporaneously with the transaction.

### CROSS REFERENCE TO RELATED APPLICATIONS

This application claims the benefit of Appl. Ser. No. 61/635,461, filed Apr. 19, 2012, which is incorporated herein by reference in its entirety.

### BACKGROUND OF THE INVENTION

There are a variety of systems and methods used to initiate a survey with a customer concerning a particular transaction or business interaction. One system and method includes initiating a survey with a customer by placing instructions on a common item to a vendor's environment, such as a coaster or a napkin, with instructs suggesting to a customer to participate in an online survey by visiting a website, which may or may not include an incentive. In order for the customer to participate in this method it requires the customer to first go to an internet web browser and then read the website that is written on the coaster or napkin and then copy that website by typing it into a web-browser. Next the customer must visit the website and then can participate. The process of relying on the customer to first notice the suggestion on the coaster or napkin to visit the website reduces the likelihood of a higher participation rate for the online survey. In addition, when the customer does participate in the online survey there is no review code provided to the customer to enter which is used to validate the transaction to associate to the review, thereby lessening the relevancy and potential utilization of the review provided by the customer.

Another system and method of initiating a survey with a customer involves recruiting a paid individual to pose as a true customer and proceed through a transaction process from beginning to end. At the conclusion of the transaction the individual who is posing as a true customer is required to participate in an online survey, then complete and submit a review regarding the transaction. This system and method can produce skewed review data, since the individual providing the review is not a true customer, who ordinarily participates in the transaction and then the review.

Another system and method of initiating a survey with a customer involves a monitor screen accessible to the customer at a vendor's physical establishment where a transaction occurs, and the customer is allowed to participate in the survey without any incentive provided to the customer in exchange for their participation. There is no means of associating the review to the proper transaction, thereby lessening the relevancy and use of the data. This method does not optimize the potential for higher participation rates of a survey since the customer is not as inclined to give their time to participate in the survey since there is not an incentive being provided to them in exchange. In addition, if the customer wanted to participate in the survey post transaction there is no option presented.

Another system and method of initiating a survey first requires a customer to download a web-based mobile application to his mobile phone. Next, the customer must create an account to be used with conjunction of the web-based mobile application. When the customer's mobile phone is within certain proximity of a vendor the customer is allowed to write a review regarding the vendor. The review is then displayed publicly throughout the web-based mobile application for anyone with access to read the customer's review of the vendor. The requirement for the customer to first having to download a web-based mobile application before being able to participate in the survey is too burdensome and time consuming to stimulate higher participation rates of a survey. There is no means of associating the review to the proper transaction, thereby lessening the relevancy and use of the data. This system and method does not optimize the potential for higher participation rates of a survey since the customer is not as inclined to give their time to participate in the survey since there is not an incentive being provided to them in exchange. This system and method does not validate that the participant of the survey is an actual customer, employee or another type of non-customer, thereby making the review data less reliable and relevant.

Another system and method of initiating a survey exists which requires a customer to send a text message to a vendor, and then the vendor sends a text message back to the customer with a URL link that when clicked by the customer automatically redirects the customer to the online survey. This system and method does not validate that the participant of the survey is an actual customer, employee or another type of non-customer, thereby making the review data less reliable and relevant. Even if it is an actual customer participating in the survey, many times there is no unique identifier provided to link the review data to the correct transaction, which also lessens the relevancy of the review data from the customer. Another drawback is that in some cases there is no incentive provided to the customer in exchange for their completion and submission of the survey. In addition, the largest hindrance prohibiting higher participation rates is that the customer is required to initiate survey participation by first sending a text message to the vendor, which is too burdensome and time consuming to stimulate higher participation rates of a survey.

Another system and method of initiating a survey with a customer involves a customer, using their mobile phone, scanning a QR Code which is used as a unique identifier to a vendor's survey. After scanning the QR Code the customer is automatically redirected to the online survey, which may or may not include an incentive to the customer in exchange for completing and submitting the review. The QR Code process is not an intuitive process, or user-friendly to many consumers which is why this system and method fails at generating higher participation rates of consumers participating in surveys. In addition, often times, the QR Code is only used as a unique identifier for the particular survey and not a unique identifier of the review data provided by the customer. Therefore, if a unique identifier was to be used to associate the review data to the correct transaction then it still requires the customer to enter the unique identifier, which is too burdensome and time consuming a process to generate higher participation rates of a survey.

Another system and method of initiating a survey involves a vendor requesting a customer to provide their email address during a transaction either to complete the transaction or the vendor tells the customer that the email will be used for product announcements, services announcements, coupons and discounts, and other announcements related to the vendor. After the transaction has concluded and the vendor has the customer's email address, the vendor sends an email to the customer requesting he participate in a survey, which may or may not include an incentive to the customer. The customer is sent an email instructing the customer to click on a URL link to begin the survey. However, the customer is not anticipating receiving an email requesting participation in a survey, which reduces the participation rate because the email to the customer has a high likelihood of being over-looked by the customer. Even if the customer does participate in the survey there is no review code provided, in the email or the URL link within the email, to associate the particular transaction to the review provided by the customer. In addition, if the customer preferred to receive the survey via text message the option does not exist for the customer, which if had, can increase the customer participation rate.

Another system and method of initiating a survey involves a vendor requesting a customer to provide their email address during a transaction either to complete the transaction or the vendor tells the customer that the email will be used for product announcements, services announcements, coupons and discounts, and other announcements related to the vendor. After the transaction has concluded and the vendor has the customer's email address, the vendor sends an email to the customer requesting he participate in a survey, which may or may not include an incentive to the customer. The customer is sent an email containing instructions to begin the survey, which first requires the customer to log in to the vendor's website before being able to participate in the survey. The process of requiring a customer to first log in to a vendor's website using their credentials is too time-consuming and burdensome an effort to generate higher customer participation rates of a survey. However, the customer is not anticipating receiving an email requesting participation in a survey, which reduces the participation rate because the email to the customer has a high likelihood of being over-looked by the customer. In addition, the option to receive the survey via text message, which would increase the customer participation rate, does not exist for the customer.

Another system and method of initiating a survey with a customer involves a vendor requesting a customer to participate in a survey after an online transaction has completed. At the conclusion of the online purchase a pop-up form displays in the webpage through the monitor screen using words displayed to the customer suggesting he participate in an online survey, which may or may not include an incentive in exchange for the completion and submission of the review. The customer has the option to either participate in the survey now, or not at all. If the customer opts to participate in the survey now and completes and submits it, then the review is submitted along with the order id number, total order value, billing zip code, and a limited amount of unique identifiers associated to the purchased product in a URL link to the inquiring vendor. This system and method fails to offer optimized metrics since the survey limits the number of products that can be given a review by the customer, even though the customer had potentially purchased more. This negatively impacts the optimization of the relevancy of the review. Also, if the customer is not available to participate in the survey now, there is not an alternative system and method presented to allow the customer to conveniently participate at a later time, which reduces the possibility of higher participation rates. In addition, this system and method of initiating a survey with a customer is applicable only to online purchases, thereby lessening even further the potential of generating higher participation rates for transactions which occur outside of an online/internet transaction.

Another system and method of initiating a survey involves a vendor requesting a customer to participate in an online survey during the customer's visitation session of a website, whether a purchase is or is not occurring. At some point during the customer's visitation session of the website, the webpage being viewed by the customer is dimmed and disabled from use, other than being able to peer around another web-based box/form that overlays the originally viewed content by the customer in the webpage. Within the web-based box/form that now overlays the originally viewed webpage content are displayed to the customer words inside the contents of the web-based box/form suggesting the customer participate in a survey without an incentive to the customer for completing and submitting the review in exchange. This system and method does not optimize the potential for higher participation rates of a survey since the customer is not as inclined to give his time to participate in a survey where there is not an incentive being provided to them in exchange. In addition, if the customer wanted to participate in the survey post transaction, then there is no option presented.

Another system and method of initiating a survey with a customer involves printing instructions on a customer's receipt which instructs the customer to participate in an online survey through a website, which in some cases does not include an incentive, though many times does. At the website, before participating in the online survey, the customer is required to enter a review code which is located on the same receipt from where it instructs the customer to visit the website to participate in the online survey. The review code from the receipt is used to associate the transaction to the proper review. This review code is used by the inquiring organization to associate many important details of a transaction to the correct review, including though not limited to: time of purchase, location of purchase, sales clerk/associate, terminal used for transaction, products purchased, services purchased, tracking the review code to prevent misuse of the review code, method of payment and amount spent. Once the review is complete and submitted, if an incentive is presented it then occurs in one of the four following ways. First, the incentive can be mailed to the customer. The problem with this medium is that the incentive is not provided to the customer quickly enough to drive participation rates to acceptable levels. Secondly, the customer can be sent a coupon code via email or text message and required to present it during a subsequent purchase to claim the incentive. Thirdly, in yet another mode, the customer is told through the verbiage displayed on the website that he has been entered into a drawing for a chance to win a prize and will be contacted if he wins. For example, a chance to win a $5,000 gift card. This ploy of entering one in a drawing that might win the customer a $5,000 gift card often times is perceived as a gimmick by customers and they can quickly lose confidence in offered incentives like this which then naturally generates unfavorable participation rates. Fourthly and finally, a customer can be offered a discount on a subsequent visit, e.g. a 10% discount off a subsequent purchase. In this method, the customer must write the coupon code that is presented at the conclusion of the review. With the coupon code written on the original receipt, the customer must surrender the original receipt upon a subsequent purchase to redeem the incentive. This process is not user-friendly enough, because the customer is required to write a coupon code on the original receipt and make sure not to lose it before a subsequent visit where he then must present and surrender the original receipt. Overall, the greatest distraction which keeps this system and method of initiating a survey with a customer from successfully generating higher participation rates is that it is not user-friendly enough to the customer. Requiring a customer to type a website URL into an internet browser and then enter a review code from the receipt onto the online survey is to the customer too time-consuming and burdensome an effort to generate higher participation rates of a survey.

The terms “participation rate” and “participation rates” is to be construed to include “the number of customers who begin a survey divided by the number of customers invited to participate in a survey.” Consequently, by increasing the customer participation rate on a survey, the potential of a survey being completed by a customer also increases, and, thereby enhances the benefit of the review to the inquiring organization. Ideally, the system and method of initiating a survey with a customer should gather review data that is reliable, broadly relevant, accurate, accessible, and should encourage a higher customer participation rate. While prior art systems and methods for initiating a survey with a customer may generally embody one or more of these qualities, i.e. reliability, relevance, accuracy, accessibility, and which encourage a higher participation rate, no known system and method embody all of these qualities.

Surveys initiated with customers should generate higher participation rates and review data that is relevant, accurate, and accessible that can be utilized in a variety of ways including, but not limited to improving process flow, enhancing customer experience, increasing profits, creating, enhancing, and enforcing organizational policy; optimizing existing products or services, or offering new products or services. Surveys initiated with customers that generate higher participation rates and review data embodying these qualities is also an important factor in training, promoting, and dismissing staff, and comprehensive customer relationship management.

Accordingly, there is a need for a system and method that can, during a transaction, incentivize higher customer participation rates on surveys by requiring a minimal amount of effort by all parties involved, while generating review data that is reliable, broadly relevant, accurate, and accessible.

### BRIEF SUMMARY OF THE INVENTION

The system and method described herein initiates a survey with a customer to generate higher customer participation rates and review data related to a transaction that is reliable, broadly relevant, accurate, and accessible making the participation of a survey as user-friendly as possible by utilizing current available technologies while fortifying all other review data attributes stated earlier. To generate higher customer participation rates of a survey before or at a transaction, the survey is provided through a monitor screen, wherein a review code is automatically generated to associate the survey to the correct transaction, and the incentive to the completed survey is immediately provided to the customer. To generate higher customer participation rates of a survey after a transaction the customer provides either a unique identifier, such as an email address, phone number, or customer identification username/number (used to retrieve an email address or phone number associated with the customer), during the transaction to which an email or text message is immediately sent with a URL link containing the review code or another unique identifier of the like that can be used to associate to the review code. When the URL link is clicked by the customer he is then immediately re-directed to the online survey which requires no review code entry by the customer because the URL link already contains the necessary credentials associated to the review code so it can later be passed at the time the online review is completed and submitted, thereby being able to associate the review to the proper transaction. The incentive associated to an online survey that is completed and submitted after a transaction is provided to the customer upon completion and submission of the review through an email or text message. To redeem the incentive, the customer merely has to present the coupon code, during a subsequent order, by itself. In addition, the coupon code is a unique identifier and can be tracked to prohibit its misuse. Not only is this system and method highly user-friendly, which inherently generates higher customer participation rates of the customer beginning a survey, but it also is user-friendly to the inquiring organization. The review data is extremely reliable and accurate since the review is assigned a unique identifying review code to associate the review to the particular transaction, relevant since the review is validated as coming from a customer, accessible since the review data is stored in a database making the review data retrievable and sortable. In addition, when customer participation rates are higher, the inquiring organization's confidence of the obtained review data is enhanced, thereby increasing the use and benefit of the review data to the inquiring organization.

In one embodiment of the claimed system and method a vendor, either before, during, or after a transaction, may initiate a survey with a customer through the medium of a monitor screen, wherein a customer or someone on behalf of a customer can input data with an incentive to the customer, wherein the review can be completed and submitted or may elect to participate in the survey post transaction by providing a unique identifier (example: email address, phone number, or customer identification username/number used to locate an email address or phone number associated to the customer) so an email or text message, containing instructions and a URL link, which contains the unique identifier known as the review code or another unique identifier of the like that can be used to associate to the review code, can be sent to the customer and the content found within the webpage, directed to by the URL link, is formatted in a user-friendly fashion for efficient readability and use by the customer, wherein upon completion and submission of a review before or during a transaction, any and all associated incentive is able to be immediately redeemed to the customer through the coupon code, wherein upon completion and submission of a review that takes place after a transaction an email can be sent to the customer's email address or text message to the customer's mobile phone with instructions, which includes a unique identifier known as a coupon code for validation purposes, being able to redeem any and all associated incentive to the customer through the coupon; and, wherein the completed and submitted review is accessible to the vendor for which the review is intended.

In another embodiment, a computer readable processor allowing for inputs and outputs of data and having readable program code therein for conducting a survey includes a computer readable program code for storing and detecting a transaction, allowing for review either during, before or after the transaction through use of a unique identifier inputted, the readable program code issues and tracks the redemption of the incentive provided for to the customer, and the readable program code processes the submitted review data.

### BRIEF DESCRIPTION OF THE DRAWINGS

FIG. 1 flow diagram illustrates the process of a transaction with an incentive to the customer for completion and submission of a review, wherein the review can occur during or after the transaction, and associated tree-branching logic with related outcomes in accordance with this embodiment.

FIG. 2 flow diagram illustrates the process of a transaction with an incentive to the customer for completion and submission of a review, wherein the review can occur before or after the transaction, and associated tree-branching logic with related outcomes in accordance with this embodiment.

FIG. 3 flow diagram illustrates the process of a transaction with an incentive to the customer for completion and submission of a review, wherein the review can occur only after the transaction, and associated tree-branching logic with related outcomes in accordance with this embodiment.

FIG. 4 flow diagram illustrates the process of a fast-food transaction with an incentive to the customer for participation in a survey, wherein a review occurs during or after the fast-food transaction, and associated tree-branching logic with related outcomes in accordance with this embodiment.

FIG. 5 flow diagram illustrates the process of a dine-in restaurant transaction with an incentive to the customer for completion and submission of a review, wherein the review can occur during or after the dine-in restaurant transaction, and associated tree-branching logic with related outcomes in accordance with this embodiment.

FIG. 6 flow diagram illustrates the process of a movie ticket purchase transaction with an incentive to the customer for completion and submission of a review, wherein the review can occur during or after the movie ticket purchase transaction, and associated tree-branching logic with related outcomes in accordance with this embodiment.

FIG. 7 flow diagram illustrates the process of a retail purchase transaction with an incentive to the customer for completion and submission of a review, wherein the review can occur during or after the retail purchase transaction, and associated tree-branching logic with related outcomes in accordance with this embodiment.

FIG. 8 flow diagram illustrates the process of a web-based application purchase transaction with an incentive to the customer for completion and submission of a review, wherein the review can occur during or after the web-based application purchase transaction, and associated tree-branching logic with related outcomes in accordance with this embodiment.

FIG. 9 flow diagram illustrates the process of a web-based application visitation transaction (no purchase) with an incentive to the customer for completion and submission of a review, wherein the review can occur during or after the web-based application visitation transaction (no purchase), and associated tree-branching logic with related outcomes in accordance with this embodiment.

FIG. 10 flow diagram illustrates the process of a dishwasher machine service transaction with an incentive to the customer for completion and submission of a review, wherein the review can occur only after the dishwasher machine service transaction, and associated tree-branching logic with related outcomes in accordance with this embodiment.

FIG. 11 flow diagram illustrates the process of an airline check-in transaction with an incentive to the customer for completion and submission of a review, wherein the review can occur only after the airline check-in transaction, and associated tree-branching logic with related outcomes in accordance with this embodiment.

FIG. 12 flow diagram illustrates the process of a hotel check-in transaction that occurs at the hotel's physical establishment with an incentive to the customer for participation in a survey, wherein a review occurs only after the hotel check-in transaction, and associated tree-branching logic with related outcomes in accordance with this embodiment.

FIG. 13 flow diagram illustrates the process of plumbing service transaction with an incentive to the customer for completion and submission of a review, wherein the review can occur only after the plumbing service transaction, and associated tree-branching logic with related outcomes in accordance with this embodiment.

FIG. 14A-14R flow diagrams illustrate possible network setups for generating and transferring content and data required for processing a transaction, survey, review, and coupon in accordance with this embodiment.

### DETAILED DESCRIPTION OF THE INVENTION

In the following description, the term “customer” should be construed to include either the customer, or a person acting on the customer's behalf; and the term “vendor” should be construed to include either a vendor, or a third party acting on behalf of the vendor; and the term “transaction” should be construed to include an exchange of goods or services between a customer and vendor; and the term “survey” should be construed to include an electronic system and method used by a vendor to propose questions and receive answers from a customer regarding one or more aspects of a particular transaction; and the term “review” should be construed to include the data from the customer in response to an electronic survey initiated by a vendor; and the term “review code” should be construed to include a unique identifier to associate a review to a survey; and the term “coupon code” should be construed to include a unique identifier used to associate an incentive for the completion and submission of a review. Broadly speaking, there is a one-to-one correspondence between a survey and a review code, a one-to-many correspondence between a transaction and a review code, a one-to-many correspondence between a review code and a coupon code, and a one-to-many correspondence between a transaction and a survey (i.e. there can be multiple surveys associated with a single transaction, with each survey regarding a particular aspect of such transaction).

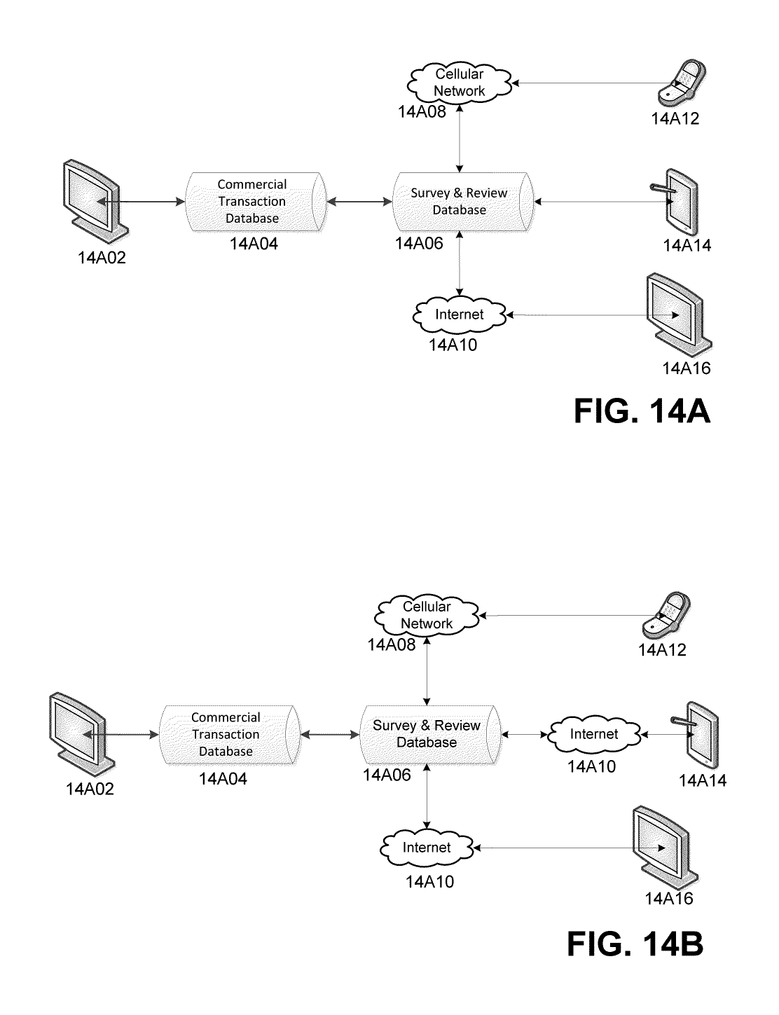

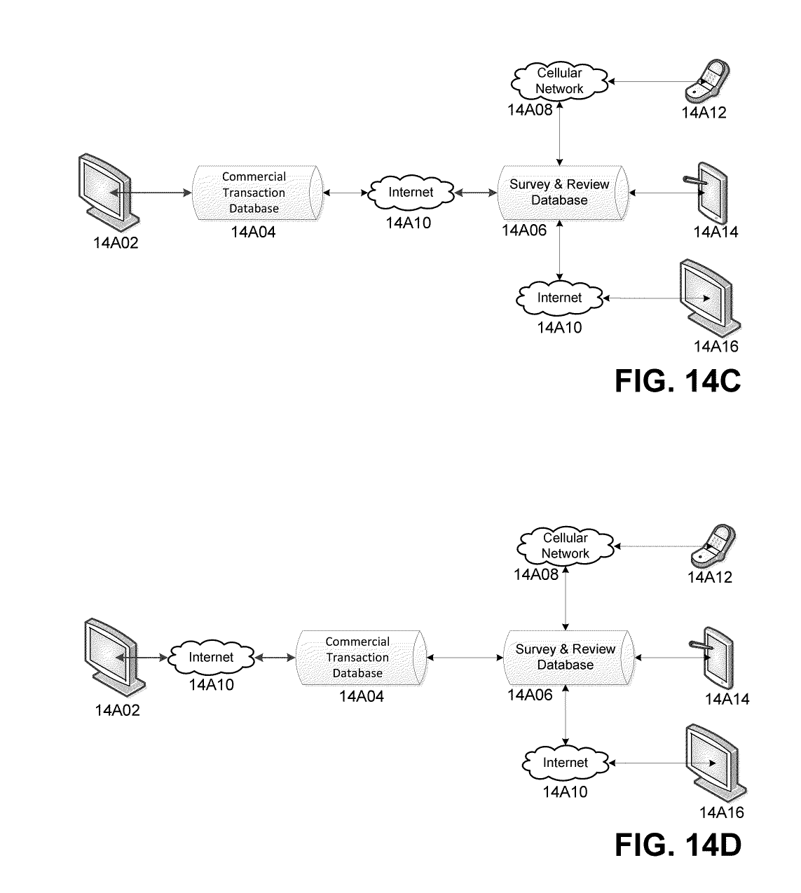

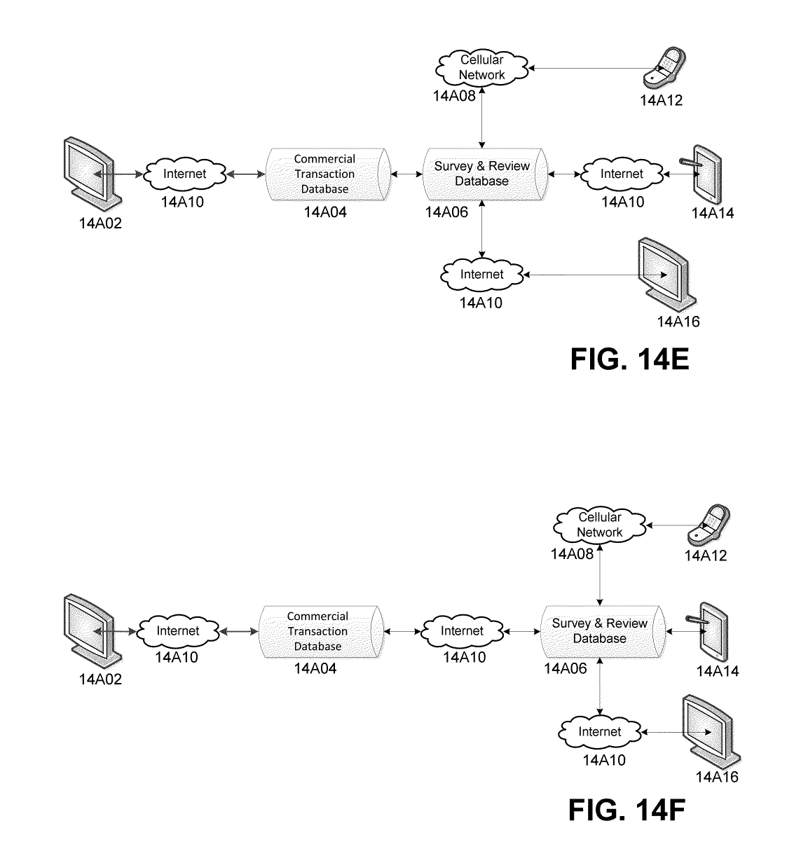

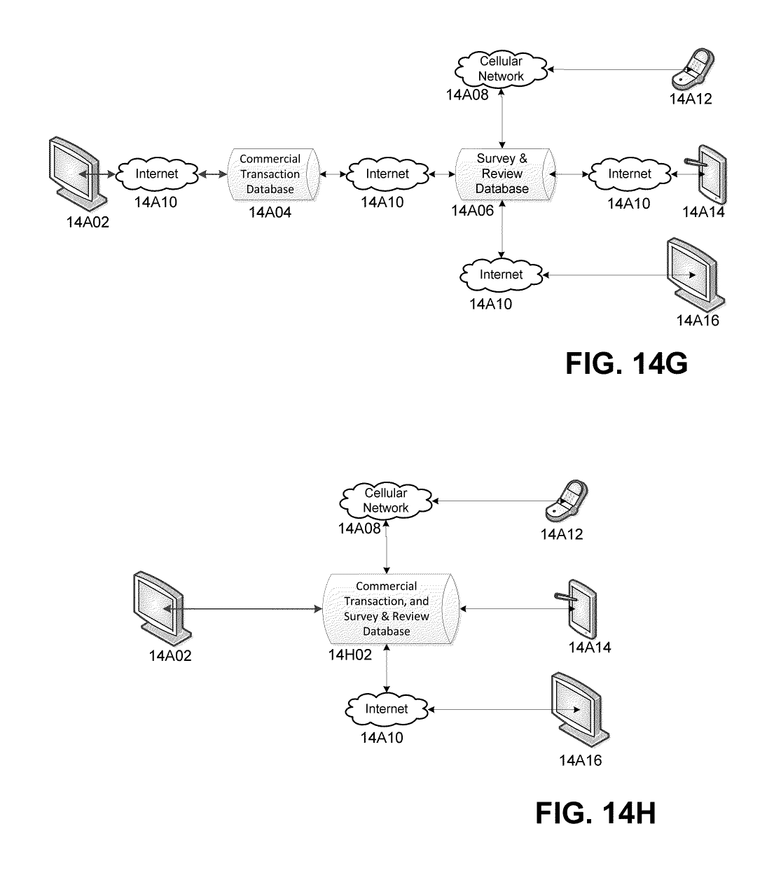

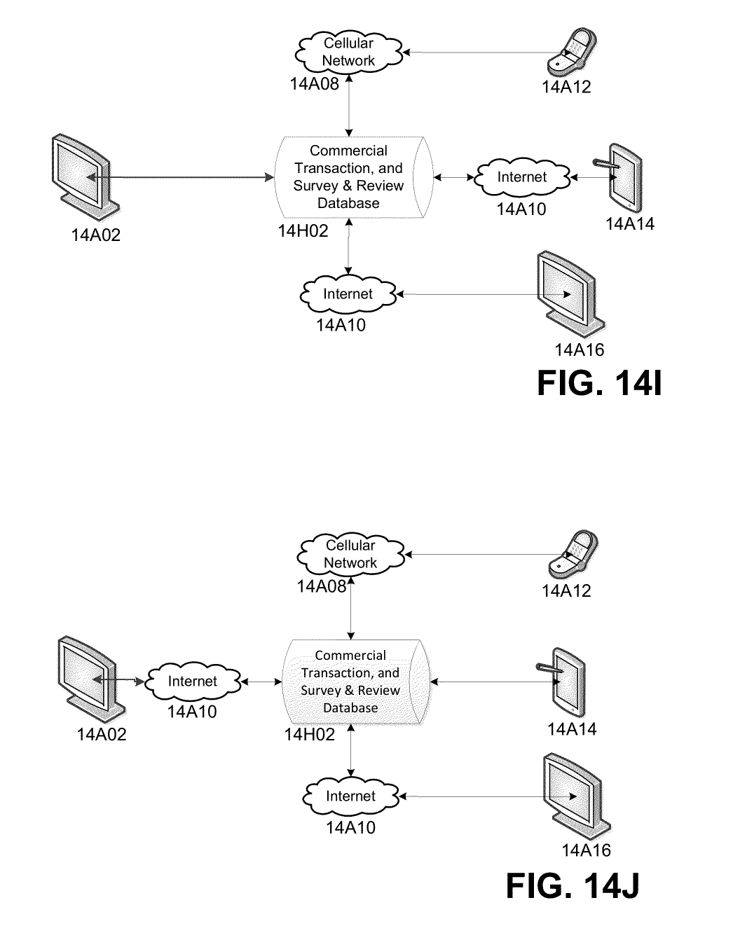

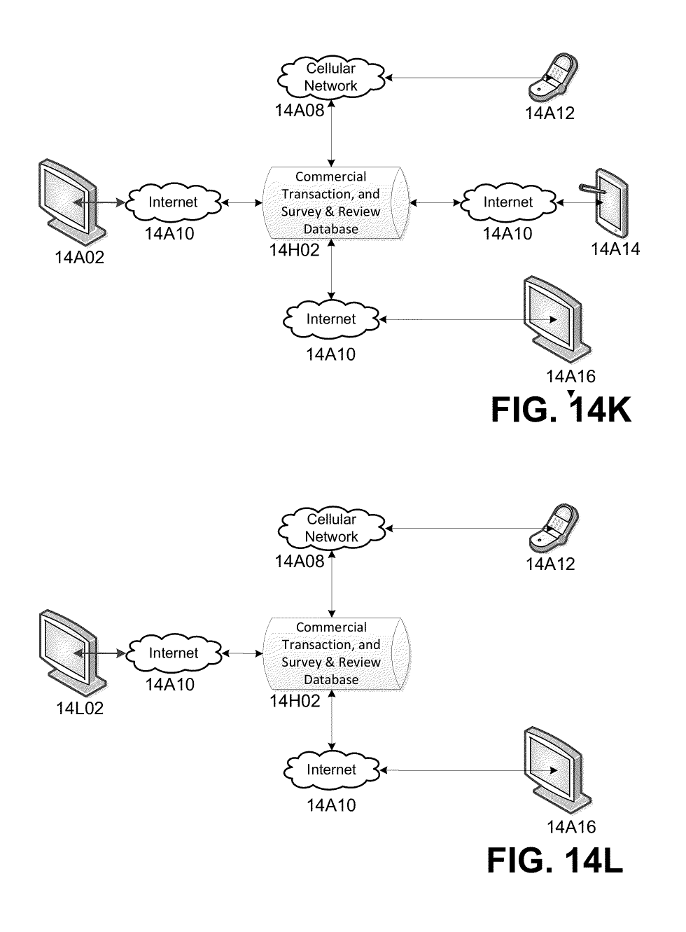

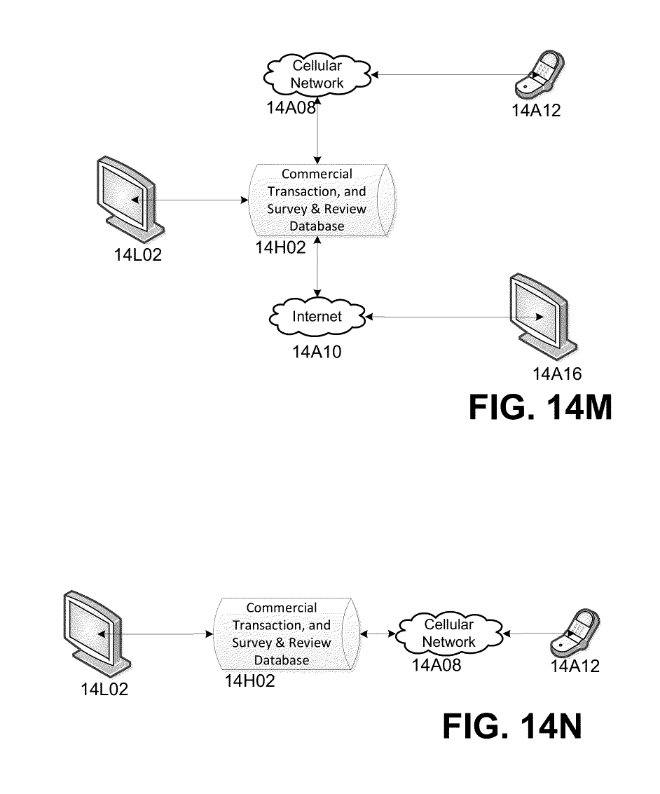

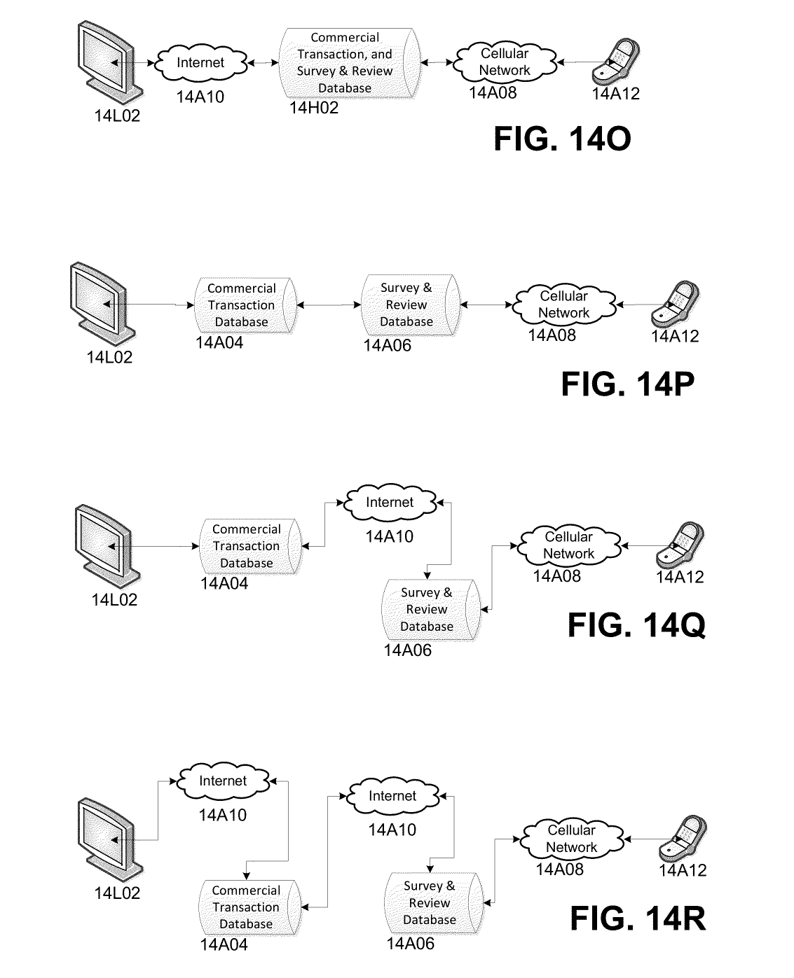

The present embodiment provides a mechanism for a vendor to initiate a survey with a customer in a user-friendly fashion given current technologies, and to provide an incentive to the customer to increase customer participation rates, and then provide the incentive to the customer upon their survey being completed and submitted to the vendor. A customer may participate in the customer survey either contemporaneously with, or after the transaction. If the customer elects to participate in the survey after the transaction, he will receive an email or text message which contains instructions and a URL link containing the unique identifier associated to the transaction that the review will be applied. Once the email or text message is sent to the customer with instructions to redeem an incentive, in which the incentive can be redeemed and the submitted review data is then immediately accessible to the vendor for that specific transaction. On the other hand, if the customer participates in the survey and then completes and submits the review contemporaneously with the transaction, he will receive an incentive that is immediately-redeemable on the transaction to which the survey refers, e.g. get a 10% discount on the item purchased. The technical means for accomplishing this system and method involve the components as shown in FIG. 14A-14R. Component labeled 14A02 is the vendor's commercial transaction computer and processor; it can be used by the vendor to display and process content and data related to a transaction or coupon. Component labeled 14A04 is the vendor's commercial transaction database; it can be used by the vendor to store transaction or coupon related data. Component labeled 14A06 is the vendor's survey and review database; it can be used to store survey and review data. Component labeled 14A08 is the customer's cellular network; it can be used as a device for transferring mobile phone content and data between two or more systems. Component labeled 14A10 is the Internet; it can be used as a device for transferring content and data between two or more systems. Component labeled 14A12 is the customer's mobile phone; it is a device that can be used by the customer to display and process content and data related to a survey, review and coupon by means of a mobile phone device. Component labeled 14A14 is the vendor's survey and review computer/tablet and processor; it is a device that can be used by the vendor to display and process content and data related to survey, review and coupon. Component labeled 14A16 is the customer's computer/tablet and processor; it is a device that can be used by the customer to display and process content and data related to a survey, review and coupon by means of a customer's computer/tablet. Component labeled 14H02 is the vendor's commercial transaction, and survey & review database; it is a device that can be used to store data related to the transaction, survey, review and coupon from the vendor and customer. Component labeled 14L02 is the vendor's computer/tablet and processor, and the survey and review computer/tablet and processor; it is a device that can be used to display and process content and data related to the transaction, survey, review and coupon from the vendor and customer. In addition, where two components exist and the medium of connection between them is not component 14A10 or component 14A08, then the medium of connection is to be presumed as either the vendor's or customer's network. As one skilled in the art will appreciate, the network architecture of the system can vary in a number of ways, as shown in FIG. 14A-14R, and, therefore, is not limited to solely the network architecture shown in FIG. 14A-14R.

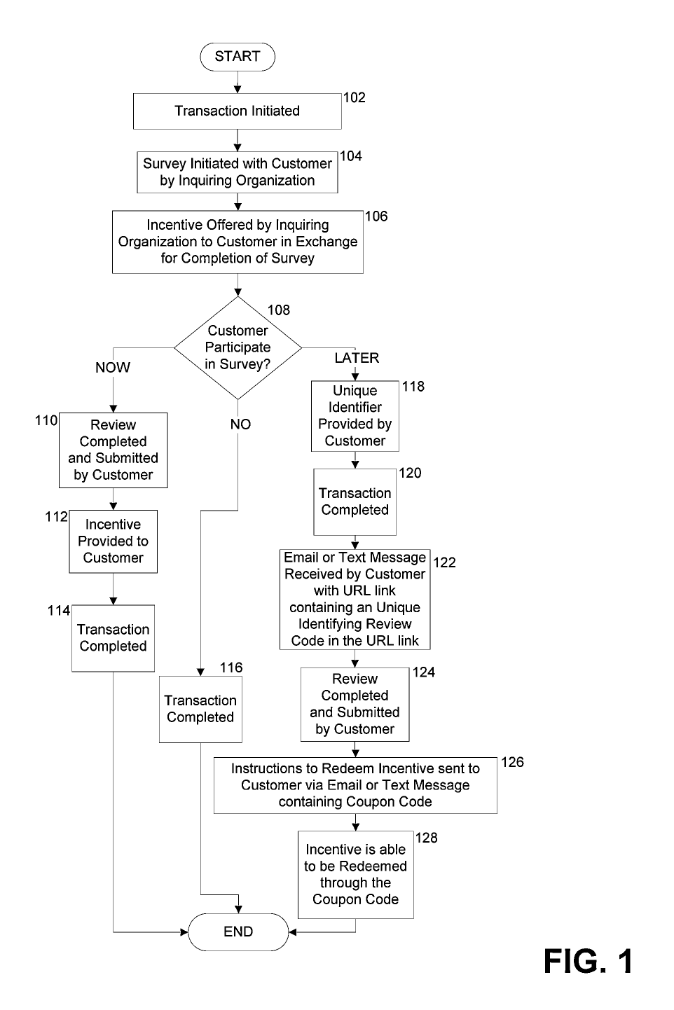

FIG. 1 is a flow chart illustrating three distinct embodiments of the method where the survey is initiated by the vendor prior to completion of the transaction. In one embodiment it includes steps 102, 104, 106, 108, 110, 112 and 114. In another embodiment it includes steps 102, 104, 106, 108 and 116. In a further embodiment, it includes steps 102, 104, 106, 108, 118, 120, 122, 124, 126 and 128.

In step 102, a customer engages in a transaction with a vendor involving an exchange of goods or services at the vendor's physical establishment with the assistance of a vendor employee through the vendor's commercial transaction computer and processor, 14A02.

In step 104, the vendor initiates a survey with the customer by either verbally asking the customer to participate in the survey or through the vendor's survey and review computer/tablet and processor, 14A14, during the transaction are displayed through the monitor screen words suggesting the customer to participate in the survey.

In step 106, the vendor offers an incentive, such as 2% off the purchase, either verbally notifying the customer of the incentive or through the vendor's survey and review computer/tablet and processor, 14A14, during the transaction are displayed through the monitor screen words notifying the customer of the incentive in exchange for the customer's completion and submission of the review.

In step 108, the customer is provided the option, either verbally from the vendor or through the vendor's survey and review computer/tablet, 14A14, to participate in the survey at the transaction, participate in the survey after the transaction by clicking a URL link within an email or a text message, or not participate in the survey. The customer's participation decision to the survey can be recorded either by the vendor with the assistance of the vendor employee through the vendor's commercial transaction computer and processor, 14A02, or entered by the customer through the vendor's survey and review computer/tablet and processor, 14A14. The data related to the customer's decision to, or not to, participate in the survey is sent to the vendor's survey and review database, 14A06.

In step 110, the customer completes and submits the review through the vendor's survey and review computer/tablet and processor, 14A14. The customer review, review code and transaction code associated to the order are generated within the vendor's survey and review database, 14A06.

In step 112, the customer is presented with the incentive, which in this example is 2% off the purchase, which is immediately applied to the order with the assistance of a vendor employee through the vendor's commercial transaction computer and processor, 14A02.

In step 114, the transaction between the customer and vendor is completed with the assistance of the vendor employee through the vendor's commercial transaction computer and processor, 14A02, and the transaction code associated to the order and the coupon code representing the incentive of 2% off the purchase, among other data elements pertaining to the order, are generated within the vendor's commercial transaction database, 14A04.

In step 116, the transaction between the customer and vendor is completed with the assistance of the vendor employee through the vendor's commercial transaction computer and processor, 14A02, and the transaction code, among other data elements pertaining to the order, are generated within the vendor's commercial transaction database, 14A04.

In step 118, the customer, or someone on behalf of the customer, inputs a unique identifier, such as an email address, phone number, or customer identification username/number in the vendor's survey and review computer/tablet and processor, 14A14, or with the assistance of the vendor employee through the vendor's commercial transaction computer and processor, 14A02, and generated in the vendor's survey and review database, 14A06.

In step 120, the transaction between the customer and vendor is completed with the assistance of the vendor employee through the vendor's commercial transaction computer and processor, 14A02, and then the unique identifier provided by the customer, along with the associated transaction code to the order, are generated within the vendor's survey and review database, 14A06.

In step 122, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 124, upon the customer clicking the URL link, which contains the unique identifier known as the review code or another unique identifier of the like that can be used to associate to the review code, he is directed to the online survey, then completes and submits the review which is sent to the vendor's survey and review database, 14A06, along with the review code, or another unique identifier of the like that can be used to associate to the review code which is associated to the original transaction.

In step 126, the vendor sends an email message via Internet, 14A10, to the email address or text message via cellular network, 14A08, to the mobile phone, 14A12, associated to the completed review with instructions, which includes a unique identifier associating the customer review with something known as a coupon code, for the customer to redeem the incentive.

In step 128, the customer presents the coupon code from the email or text message instructing the customer how to redeem the incentive. The coupon code can either be verbally provided by the customer to the vendor and a vendor employee can enter the coupon code in the vendor's commercial transaction computer and processor, 14A02, or the customer can enter the coupon code into the vendor's survey and review computer/tablet and processor, 14A14. Upon verification of the coupon code the incentive of 2% off the order is applied to the purchase, and when the transaction has concluded the coupon code and transaction code associated to the order, among other data elements pertaining to the order, are generated in the vendor's commercial transaction database, 14A04.

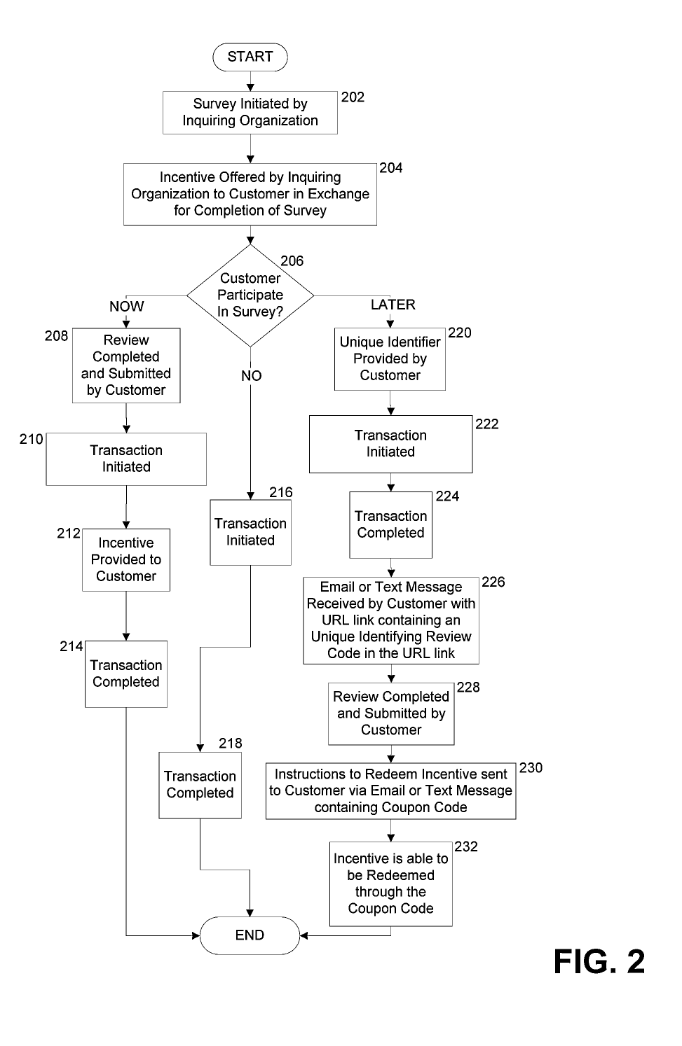

FIG. 2 is a flow chart illustrating three distinct embodiments where the vendor initiates the survey prior to initiating the transaction. In one example of the embodiment it includes steps 202, 204, 206, 208, 210, 212 and 214. In another example of the embodiment it includes steps 202, 204, 206, 216 and 218. In another example of the embodiment it includes steps 202, 204, 206, 220, 222, 224, 226, 228, 230 and 232.

In step 202, the vendor initiates a survey with the customer by either verbally asking the customer to participate in the survey or through the vendor's survey and review computer/tablet and processor, 14A14, are displayed through the monitor screen words suggesting the customer to participate in the survey.

In step 204, the vendor offers an incentive, such as 2% off the purchase, either verbally notifying the customer of the incentive or through the vendor's survey and review computer/tablet and processor, 14A14, during the transaction are displayed through the monitor screen words notifying the customer of the incentive in exchange for the customer's completion and submission of the review.

In step 206, the customer is provided the option, either verbally from the vendor or through the vendor's survey and review computer/tablet, 14A14, to participate in the survey before the transaction, participate in the survey after the transaction by clicking a URL link within an email or a text message, or not participate in the survey. The customer's participation decision to the survey can be recorded either by a vendor employee through the vendor's commercial transaction computer and processor, 14A02, or entered by the customer through the vendor's survey and review computer/tablet and processor, 14A14. The data related to the customer's decision to, or not to, participate in the survey is sent to the vendor's survey and review database, 14A06.

In step 208, the customer completes and submits the review through the vendor's survey and review computer/tablet and processor, 14A14. The customer review, review code and transaction code associated to the order, from step 210, are generated within the vendor's survey and review database, 14A06.

In step 210, the customer engages in a transaction with the vendor involving an exchange of goods or services at the vendor's physical establishment with the assistance of the vendor employee through the vendor's commercial transaction computer and processor, 14A02.

In step 212, the customer is presented with the incentive, which in this example is 2% off the purchase, which is immediately applied to the order with the assistance of the vendor employee through the vendor's commercial transaction computer and processor, 14A02.

In step 214, the customer completed and submitted the review and the transaction between the customer and vendor is completed through the vendor's survey and review computer/tablet and processor, 14A14, then the transaction code associated to the order and the coupon code representing the incentive of 2% off the purchase, among other data elements pertaining to the order, are generated within the vendor's commercial transaction database, 14A04.

In step 216, the customer engages in a transaction with the vendor involving an exchange of goods or services at the vendor's physical establishment with the assistance of the vendor employee through the vendor's commercial transaction computer and processor, 14A02.

In step 218, the transaction between the customer and vendor is completed with the assistance of a vendor employee through the vendor's commercial transaction computer and processor, 14A02, and the transaction code, among other data elements pertaining to the order, are generated within the vendor's commercial transaction database, 14A04.

In step 220, the customer, or someone on behalf of the customer, inputs a unique identifier, such as an email address, phone number, or customer identification username/number in the vendor's survey and review computer/tablet and processor, 14A14, or with the assistance of the vendor employee through the vendor's commercial transaction computer and processor, 14A02, and generated in the vendor's survey and review database, 14A06.

In step 222, the customer engages in a transaction with the vendor involving an exchange of goods or services at the vendor's physical establishment with the assistance of a vendor employee through the vendor's commercial transaction computer and processor, 14A02.

In step 224, the transaction between the customer and vendor is completed with the assistance of the vendor employee through the vendor' commercial transaction computer and processor, 14A02, and the transaction code, among other data elements associated to the order, are generated within the vendor's commercial transaction database, 14A04. At the same time, the review code, transaction code associated to the order, and customer's unique identifier are generated within the vendor's commercial survey and review database, 14A06.

In step 226, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 228, upon the customer clicking the URL link, which contains the unique identifier known as the review code or another unique identifier of the like that can be used to associate to the review code, he is directed to the online survey, then completes and submits the review which is sent to the vendor's survey and review database, 14A06, along with the review code, or another unique identifier of the like that can be used to associate to the review code, associated to the original transaction that is in the URL link.

In step 230, the vendor sends the customer an email message via Internet, 14A10, to the email address or text message via cellular network, 14A08, to the mobile phone, 14A12, associated to the completed review with instructions, which includes a unique identifier association the customer review with something known as a coupon code, for the customer to redeem the incentive.

In step 232, the customer presents the coupon code from the email or text message instructing the customer how to redeem the incentive. The coupon code can either be verbally provided by the customer to the vendor and a vendor employee can enter the coupon code in the vendor's commercial transaction computer and processor, 14A02, or the customer can enter the coupon code into the vendor's survey and review computer/tablet and processor, 14A14, during the transaction. Upon verification of the coupon code the incentive of 2% is applied to the order, and when the transaction has concluded the coupon code and transaction code associated to the order, among other data elements pertaining to the order, are generated in the vendor's commercial transaction database, 14A04.

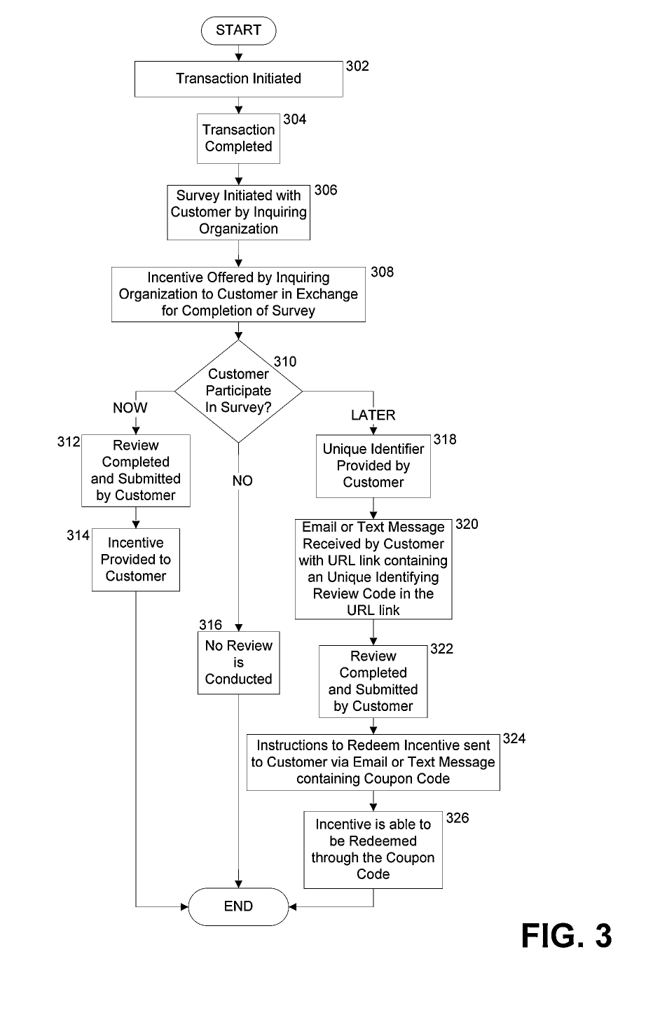

FIG. 3 is a flow chart illustrating three distinct embodiments where the vendor initiates the survey after completion of the transaction. In one example of the embodiment it includes steps 302, 304, 306, 308, 310, 312 and 314. In another example of the embodiment it includes steps 302, 304, 306, 308, 310 and 316. In another example of the embodiment it includes steps 302, 304, 306, 308, 310, 318, 320, 322, 324 and 326.

In step 302, a customer engages in a transaction with a vendor involving an exchange of goods or services at the vendor's physical establishment with the assistance of a vendor employee through the vendor's commercial transaction computer and processor, 14A02.

In step 304, the transaction between the customer and vendor is completed with the assistance of the vendor employee through the vendor' commercial transaction computer and processor, 14A02, and the transaction code associated to the order, among other data elements pertaining to the order, are generated within the vendor's commercial transaction database, 14A04.

In step 306, the vendor initiates a survey with the customer by either verbally asking the customer to participate in the survey or through the vendor's survey and review computer/tablet and processor, 14A14, are displayed through the monitor screen words suggesting the customer to participate in the survey.

In step 308, the vendor offers an incentive, such as a $5 gift card, either verbally notifying the customer of the incentive or through the vendor's survey and review computer/tablet and processor, 14A14, during the transaction are displayed through the monitor screen words notifying the customer of the incentive in exchange for the customer's completion and submission of the review.

In step 310, the customer is provided the option, either verbally from the vendor or through the vendor's survey and review computer/tablet and processor, 14A14, to participate in the survey now, participate in the survey after the transaction by clicking a URL link within an email or a text message, or not participate in the survey. The customer's participation decision to the survey can be recorded either by the vendor employee through the vendor's commercial transaction computer and processor, 14A02, or entered by the customer through the vendor's survey and review computer/tablet and processor, 14A14. The data related to the customer's decision to, or not to, participate in the survey is sent to the vendor's survey and review database, 14A06.

In step 312, the customer completes and submits the review through the vendor's survey and review computer/tablet and processor, 14A14. The customer review, review code and transaction code associated to the order are generated within the vendor's survey and review database, 14A06.

In step 314, the customer is presented with the incentive, which in this example is a $5 gift card, and is redeemable towards a subsequent purchase with the assistance of the vendor employee through the vendor's commercial transaction computer and processor, 14A02.

In step 316, no review is conducted by the customer and the customer's participation decision to the survey can be recorded either by the vendor employee through the vendor's commercial transaction computer and processor, 14A02, or entered by the customer through the vendor's survey and review computer/tablet and processor, 14A14.

In step 318, the customer, or someone on behalf of the customer, inputs a unique identifier, such as an email address, phone number, or customer identification username/number in the vendor's survey and review computer/tablet and processor, 14A14, or with the assistance of a vendor employee through the vendor's commercial transaction computer and processor, 14A02, and generated in the vendor's survey and review database, 14A06.

In step 320, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 322, upon the customer clicking the URL link, which contains the unique identifier known as the review code or another unique identifier of the like that can be used to associate to the review code, he is directed to the online survey, then completes and submits the review which is sent to the vendor's survey and review database, 14A06, along with the review code, or another unique identifier of the like that can be used to associate to the review code, associated to the original transaction that is in the URL link.

In step 324, the vendor sends the customer an email message via Internet, 14A10, to the email address or text message via cellular network, 14A08, to the mobile phone, 14A12, associated to the completed review with instructions, which includes a unique identifier association the customer review with something known as a coupon code, for the customer to redeem the incentive.

In step 326, the customer presents the coupon code, which is used to represent the $5 gift card, from the email or text message instructing the customer how to redeem the incentive. The coupon code can either be verbally provided by the customer to the vendor and a vendor employee can enter the coupon code in the vendor's commercial transaction computer and processor, 14A02, or the customer can enter the coupon code into the vendor's survey and review computer/tablet and processor, 14A14, during the transaction. Upon verification of the coupon code the incentive of the $5 gift card is applied to the order, and when the transaction has concluded the coupon code and transaction code associated to the order, among other data elements pertaining to the order, are generated in the vendor's commercial transaction database, 14A04.

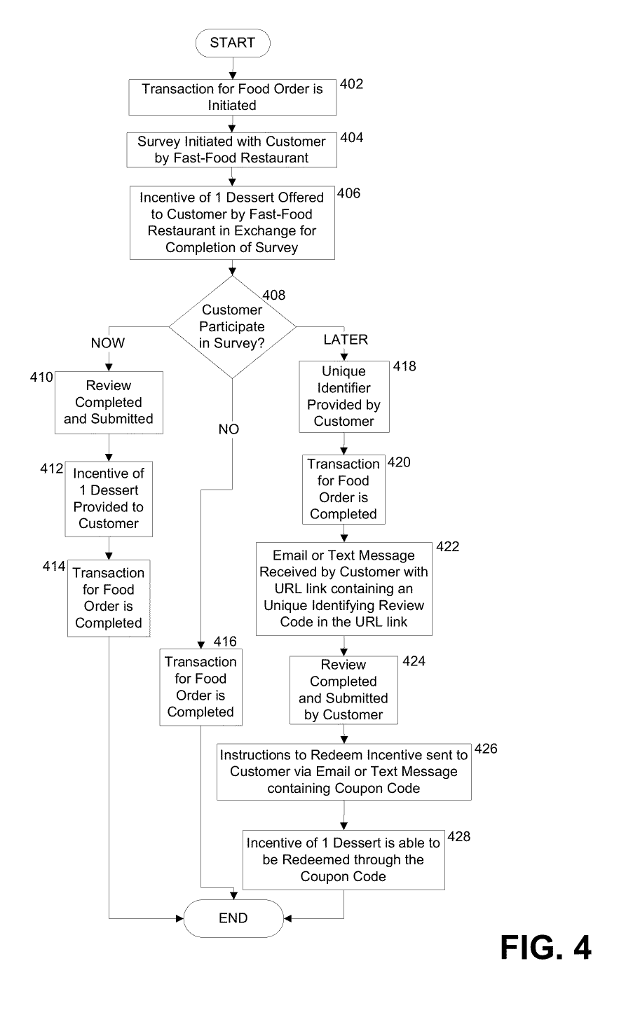

FIG. 4 is a flow chart illustrating the invention as applied to a fast-food transaction. In one example of the embodiment it includes steps 402, 404, 406, 408, 410, 412 and 414. In another example of the embodiment it includes steps 402, 404, 406, 408 and 416. In another example of the embodiment it includes steps 402, 404, 406, 408, 418, 420, 422, 424, 426 and 428.

In step 402, a customer engages in a transaction with a fast-food vendor involving the purchase of some fast-food at the vendor's physical establishment with the assistance of a fast-food employee through the vendor's commercial transaction computer and processor, 14A02.

In step 404, the fast-food employee initiates a survey with the customer by either verbally asking the customer to participate in the survey or through the fast-food vendor's survey and review computer/tablet and process, 14A14, during the transaction are displayed through the monitor screen words suggesting the customer to participate in the survey.

In step 406, the fast-food vendor offers an incentive, such as 1 dessert item, either verbally notifying the customer of the incentive or through the fast-food vendor's survey and review computer/tablet and processor, 14A14, during the transaction are displayed through the monitor screen words notifying the customer of the incentive in exchange for the customer's completion and submission of the review.

In step 408, the customer is provided the option, either verbally from the fast-food vendor or through the vendor's survey and review computer/tablet, 14A14, to participate in the survey at the transaction, participate in the survey after the transaction by clicking a URL link within an email or a text message, or not participate in the survey. The customer's participation decision to the survey can be recorded either by the fast-food employee through the fast-food vendor's commercial transaction computer and processor, 14A02, or entered by the customer through the fast-food vendor's survey and review computer/tablet and processor, 14A14. The data related to the customer's decision to, or not to, participate in the survey is sent to the fast-food vendor's survey and review database, 14A06.

In step 410, the customer completes and submits the review through the fast-food vendor's survey and review computer/tablet and processor, 14A14. The customer review, review code and transaction code associated to the order are generated within the fast-food vendor's survey and review database, 14A06.

In step 412, the customer is presented with the incentive, which in this example is 1 dessert item, which is immediately applied to the order with the assistance of the fast-food employee through the fast-food vendor's commercial transaction computer and processor, 14A02.

In step 414, the transaction between the customer and fast-food vendor is completed with the assistance of the fast-food employee through the fast-food vendor's commercial transaction computer and processor, 14A02, and the transaction code associated to the order and the coupon code representing the incentive of 1 dessert item, among other data elements pertaining to the order, are generated within the fast-food vendor's commercial transaction database, 14A04.

In step 416, the transaction between the customer and fast-food vendor is completed with the assistance of the fast-food employee through the fast-food vendor's commercial transaction computer and processor, 14A02, and the transaction code associated to the fast-food order, among other data elements pertaining to the order, are generated within the fast-food vendor's commercial transaction database, 14A04.

In step 418, the customer, or someone on behalf of the customer, inputs a unique identifier, such as an email address, phone number, or customer identification username/number in the fast-food vendor's survey and review computer/tablet and processor, 14A14, or with the assistance of the fast-food employee through the fast-food vendor's commercial transaction computer and processor, 14A02, and generated in the fast-food vendor's survey and review database, 14A06.

In step 420, the transaction between the customer and fast-food vendor is completed with the assistance of the fast-food employee through the fast-food vendor's commercial transaction computer and processor, 14A02, and then the unique identifier provided by the customer, along with the associated transaction code to the order, are generated within the fast-food vendor's survey and review database, 14A06.

In step 422, using the unique identifier provided by the customer, the fast-food vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the fast-food vendor (or a third-party acting on behalf of the vendor) other than customer's email address or phone number, then this unique identifier is used to retrieve an email address or phone number associated with the customer for the fast-food vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 424, upon the customer clicking the URL link, which contains the unique identifier known as the review code or another unique identifier of the like that can be used to associate to the review code, he is directed to the online survey, then completes and submits the review which is sent to the fast-food vendor's survey and review database, 14A06, along with the review code, or another unique identifier of the like that can be used to associate to the review code, associated to the original transaction.

In step 426, the fast-food vendor sends an email message via Internet, 14A10, to the email address or text message via cellular network, 14A08, to the mobile phone, 14A12, associated to the completed and submitted review with instructions, which includes a unique identifier associating the customer review with something known as a coupon code, for the customer to redeem the incentive of 1 dessert item.

In step 428, the customer presents the coupon code from the email or text message instructing the customer how to redeem the incentive. The coupon code can either be verbally provided by the customer to the fast-food employee and a fast-food employee can enter the coupon code in the fast-food vendor's commercial transaction computer and processor, 14A02, or the customer can enter the coupon code into the fast-food vendor's survey and review computer/tablet and processor, 14A14. Upon verification of the coupon code the incentive of 1 dessert item is applied to the purchase, and when the transaction has concluded the coupon code and transaction code associated to the order, among other data elements pertaining to the order, are generated in the fast-food vendor's commercial transaction database, 14A04.

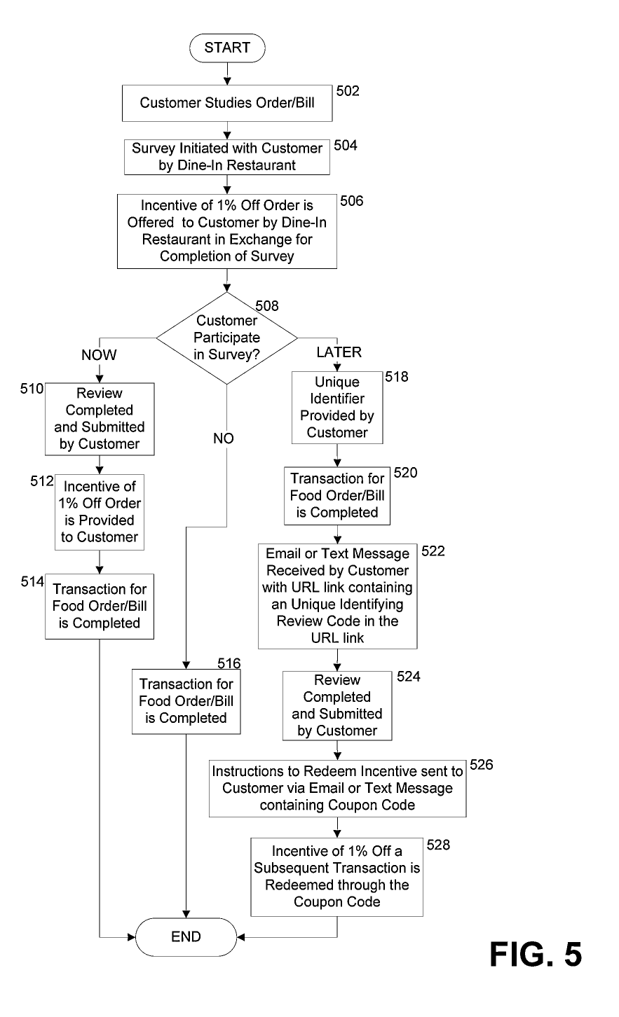

FIG. 5 is a flow chart illustrating the invention as applied to a dine-in restaurant purchase transaction. In one example of the embodiment it includes steps 502, 504, 506, 508, 510, 512 and 514. In another example of the embodiment it includes steps 502, 504, 506, 508 and 516. In another example of the embodiment it includes steps 502, 504, 506, 508, 518, 520, 522, 524, 526 and 528.

In step 502, a customer is studying his order/bill, either on a paper receipt or vendor's computer/tablet and processor, and survey and review computer/tablet and processor, 14L02, from a dine-in restaurant where he ate at the dine-in vendor's physical establishment.

In step 504, the dine-in vendor initiates a survey with the customer by either verbally asking the customer to participate in the survey or through the dine-in vendor's computer/tablet and processor, and survey and review computer/tablet and processor, 14L02, during the transaction are displayed through the monitor screen words suggesting the customer to participate in the survey.

In step 506, the dine-in vendor offers an incentive, such as 1% off the order/bill, either verbally notifying the customer of the incentive or through the dine-in vendor's computer/tablet and processor, and survey and review computer/tablet and processor, 14L02, during the transaction are displayed through the monitor screen words notifying the customer of the incentive in exchange for the customer's completion and submission of the review.

In step 508, the customer is provided the option, either verbally by the dine-in vendor or through the dine-in vendor's computer/tablet and processor, and survey and review computer/tablet and processor, 14L02, to participate in the survey at the transaction, participate in the survey after the transaction by clicking a URL link within an email or a text message, or not participate in the survey. The customer's participation decision to the survey can be recorded either by the dine-in employee or the customer using the vendor's computer/tablet and processor, and survey and review computer/tablet and processor, 14L02. The data related to the customer's decision to, or not to, participate in the survey is sent to the dine-in vendor's commercial transaction, and survey and review database, 14H02.

In step 510, the customer completes and submits the review through the dine-in vendor's computer/tablet and processor, and survey and review computer/tablet and processor, 14L02. The customer review, review code and transaction code associated to the order are generated within the dine-in vendor's commercial transaction, and survey and review database, 14H02.

In step 512, the customer is presented with the incentive, which in this example is 1% off the order/bill, which is immediately applied to the order through the dine-in vendor's computer/tablet and processor, and survey and review computer/tablet and processor, 14L02.

In step 514, the transaction between the customer and dine-in vendor is completed through the dine-in vendor's computer/tablet and processor, and survey and review computer/tablet and processor, 14L02, and the transaction code associated to the order and the coupon code representing the incentive of 1% off the order/bill, among other data elements pertaining to the order, are generated within the dine-in vendor's commercial transaction, and survey and review database, 14H02.

In step 516, the transaction between the customer and dine-in vendor is completed with the assistance of the dine-in employee through the dine-in vendor's computer/tablet and processor, and survey and review computer/tablet and processor, 14L02, and the transaction code associated to the dine-in order and the coupon code, among other data elements pertaining to the order, are generated within the fast-food vendor's commercial transaction, and survey and review database, 14H02.

In step 518, the customer, or someone on behalf of the customer, inputs a unique identifier, such as an email address, phone number, or customer identification username/number in the dine-in vendor's computer/tablet and processor, and survey and review computer/tablet and processor, 14L02, and generated in the dine-in vendor's commercial transaction, and survey and review database, 14H02.

In step 520, the transaction between the customer and dine-in vendor is completed through the dine-in vendor's computer/tablet and processor, and survey and review computer/tablet and processor, 14L02, and then the unique identifier provided by the customer, along with the associated transaction code to the order, are generated within the dine-in vendor's commercial transaction, and survey and review database, 14H02.

In step 522, using the unique identifier provided by the customer, the dine-in vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the dine-in vendor (or a third-party acting on behalf of the vendor) other than customer's email address or phone number, then this unique identifier is used to retrieve an email address or phone number associated with the customer for the dine-in vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 524, upon the customer clicking the URL link, which contains the unique identifier known as the review code or another unique identifier of the like that can be used to associate to the review code, he is directed to the online survey, then completes and submits the review which is sent to the dine-in vendor's commercial transaction, and survey and review database, 14H02, along with the review code, or another unique identifier of the like that can be used to associate to the review code, associated to the original transaction.

In step 526, the dine-in vendor sends an email message via Internet, 14A10, to the email address or text message via cellular network, 14A08, to the mobile phone, 14A12, associated to the completed review with instructions, which includes a unique identifier associating the customer review with something known as a coupon code, for the customer to redeem the incentive of 1% off a subsequent order/bill.

In step 528, the customer presents the coupon code from the email or text message instructing the customer how to redeem the incentive. The coupon code can either be verbally provided by the customer to the vendor and the vendor can enter the coupon code in the vendor's computer/tablet and processor, and survey and review computer/tablet and processor, 14L02, or the customer can enter the coupon code into the vendor's computer/tablet and processor, and survey and review computer/tablet and processor, 14L02. Upon verification of the coupon code the incentive of 1% off an order/bill is applied to the purchase, and when the transaction has concluded the coupon code and transaction code associated to the order, among other data elements pertaining to the order, are generated in the dine-in vendor's commercial transaction, and survey and review database, 14H02.

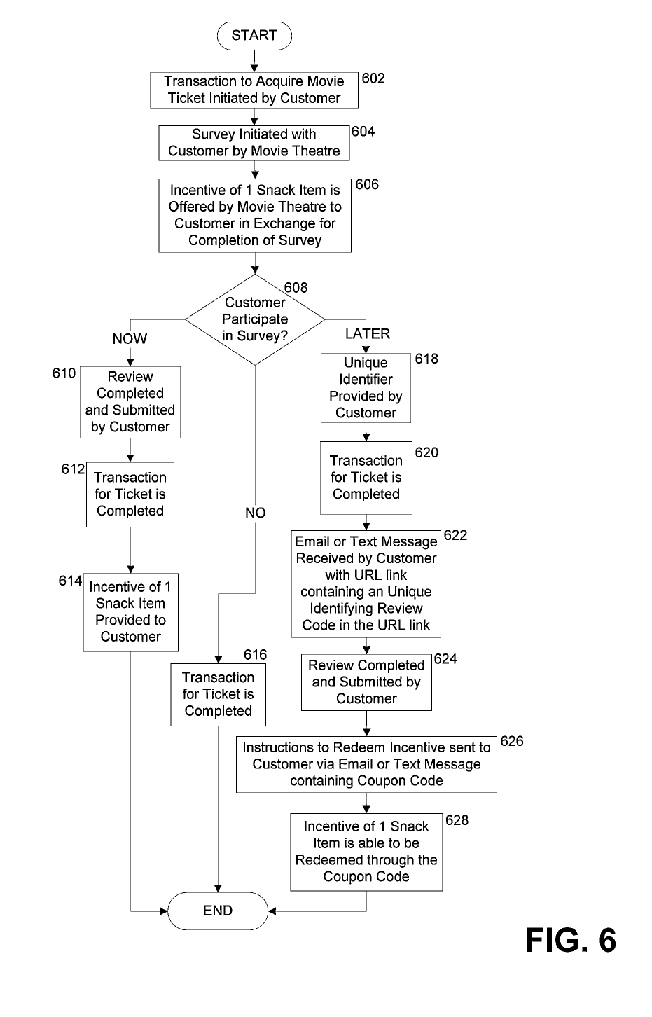

FIG. 6 is a flow chart illustrating the invention as applied to a movie ticket purchase transaction. In one example of the embodiment it includes steps 602, 604, 606, 608, 610, 612 and 614. In another example of the embodiment it includes steps 602, 604, 606, 608 and 616. In another example of the embodiment it includes steps 602, 604, 606, 608, 618, 620, 622, 624, 626 and 628.

In step 602, a customer engages in a transaction with a movie theater vendor to purchase a movie ticket at the movie theater vendor's physical establishment with the assistance of a movie theater employee through the movie theater vendor's commercial transaction computer and processor, 14A02.

In step 604, the movie theater vendor initiates a survey with the customer by either verbally asking the customer to participate in the survey or through the movie theater vendor's survey and review computer/tablet and processor, 14A14, during the transaction are displayed through the monitor screen words suggesting the customer to participate in the survey.

In step 606, the movie theater vendor offers an incentive of 1 snack item either verbally notifying the customer of the incentive or through the movie theater vendor's survey and review computer/tablet and processor, 14A14, during the transaction are displayed through the monitor screen words notifying the customer of the incentive in exchange for the customer's completion and submission of the review.

In step 608, the customer is provided the option, either verbally from the movie theater vendor or through the movie theater vendor's survey and review computer/tablet, 14A14, to participate in the survey at the transaction, participate in the survey after the transaction by clicking a URL link within an email or a text message, or not participate in the survey. The customer's participation decision to the survey can be recorded either by the movie theater employee through the movie theater vendor's commercial transaction computer and processor, 14A02, or entered by the customer through the movie theater vendor's survey and review computer/tablet and processor, 14A14. The data related to the customer's decision to, or not to, participate in the survey is sent to the movie theater vendor's survey and review database, 14A06.

In step 610, the customer completes and submits the review through the movie theater vendor's survey and review computer/tablet and processor, 14A14. The customer review, review code and transaction code associated to the order are generated within the movie theater vendor's survey and review database, 14A06.

In step 612, the transaction between the customer and movie theater vendor is completed with the assistance of the movie theater employee through the movie theater vendor's commercial transaction computer and processor, 14A02, and the transaction code associated to the movie ticket order and the coupon code representing the incentive of 1 snack item, among other data elements pertaining to the order, are generated within the movie theater vendor's commercial transaction database, 14A04.

In step 614, the customer is presented with the coupon code either on a piece of paper or presented through an email via Internet, 14A10, to the customer's email address, or through text message via cellular network, 14A08, to the customer's mobile phone, 14A12, that contains a coupon code that is immediately redeemable towards the incentive of 1 snack item with the assistance of the movie theater employee through the movie theater vendor's commercial transaction computer and processor, 14A02.

In step 616, the transaction between the customer and movie theater vendor is completed with the assistance of the movie theater employee through the movie theater vendor's commercial transaction computer and processor, 14A02, and the transaction code, among other data elements pertaining to the order, are generated within the movie theater vendor's commercial transaction database, 14A04.

In step 618, the customer, or someone on behalf of the customer, inputs a unique identifier, such as an email address, phone number, or customer identification username/number in the movie theater vendor's survey and review computer/tablet and processor, 14A14, or with the assistance of the movie theater employee through the movie theater vendor's commercial transaction computer and processor, 14A02, and generated in the movie theater vendor's survey and review database, 14A06.

In step 620, the transaction between the customer and movie theater vendor is completed with the assistance of the movie theater employee through the movie theater vendor's commercial transaction computer and processor, 14A02, and then the unique identifier provided by the customer, along with the associated transaction code to the order, are generated within the movie theater vendor's survey and review database, 14A06.

In step 622, using the unique identifier provided by the customer, the movie theater vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the movie theater vendor (or a third-party acting on behalf of the vendor) other than customer's email address or phone number, then this unique identifier is used to retrieve an email address or phone number associated with the customer for the movie theater vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 624, upon the customer clicking the URL link, which contains the unique identifier known as the review code or another unique identifier of the like that can be used to associate to the review code, he is directed to the online survey, then completes and submits the review which is sent to the movie theater vendor's survey and review database, 14A06, along with the review code, or another unique identifier of the like that can be used to associate to the review code, associated to the original transaction.

In step 626, the movie theater vendor sends an email message via Internet, 14A10, to the email address or text message via cellular network, 14A08, to the mobile phone, 14A12, associated to the completed review with instructions, which includes a unique identifier associating the customer review with something known as a coupon code, for the customer to redeem the incentive of 1 snack item.

In step 628, the customer presents the coupon code from the email or text message instructing the customer how to redeem the incentive. The coupon code can either be verbally provided by the customer to the movie theater vendor and a movie theater employee can enter the coupon code in the movie theater vendor's commercial transaction computer and processor, 14A02, or the customer can enter the coupon code into the movie theater vendor's survey and review computer/tablet and processor, 14A14. Upon verification of the coupon code the incentive of 2% off the purchase is applied, and when the transaction has concluded the coupon code and transaction code associated to the order, among other data elements pertaining to the order, are generated in the movie theater vendor's commercial transaction database, 14A04.

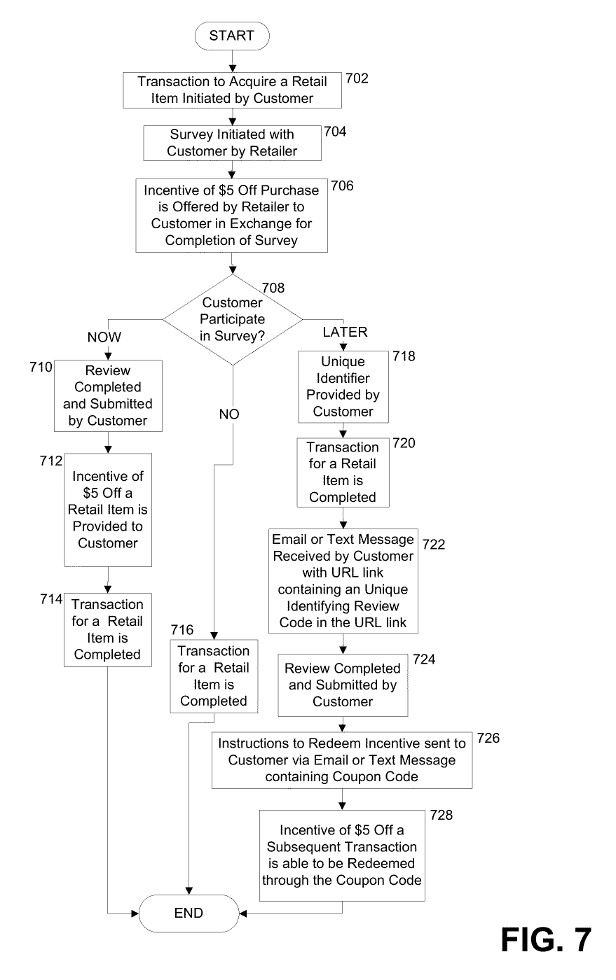

FIG. 7 is a flow chart illustrating the invention as applied to a purchase of a retail item with a retail vendor. In one example of the embodiment it includes steps 702, 704, 706, 708, 710, 712 and 714. In another example of the embodiment it includes steps 702, 704, 706, 708 and 716. In another example of the embodiment it includes steps 702, 704, 706, 708, 718, 720, 722, 724, 726 and 728.

In step 702, a customer engages in a transaction with a retail vendor to purchase a retail item at the retail vendor's physical establishment with the assistance of a retail employee through the retail vendor's commercial transaction computer and processor, 14A02.

In step 704, the retail vendor initiates a survey with the customer by either verbally asking the customer to participate in the survey or through the retail vendor's survey and review computer/tablet and processor, 14A14, during the transaction are displayed through the monitor screen words suggesting the customer to participate in the survey.

In step 706, the retail vendor offers an incentive of $5 off purchase by either verbally notifying the customer of the incentive or through the retail vendor's survey and review computer/tablet and processor, 14A14, during the transaction are displayed through the monitor screen words notifying the customer of the incentive in exchange for the customer's completion and submission of the review.

In step 708, the customer is provided the option, either verbally from the retail vendor or through the retail vendor's survey and review computer/tablet, 14A14, to participate in the survey at the transaction, participate in the survey after the transaction by clicking a URL link within an email or a text message, or not participate in the survey. The customer's participation decision to the survey can be recorded either by the retail employee through the retail vendor's commercial transaction computer and processor, 14A02, or entered by the customer through the retail vendor's survey and review computer/tablet and processor, 14A14. The data related to the customer's decision to, or not to, participate in the survey is sent to the retail vendor's survey and review database, 14A06.

In step 710, the customer completes and submits the review through the retail vendor's survey and review computer/tablet and processor, 14A14. The customer review, review code and transaction code associated to the order are generated within the retail vendor's survey and review database, 14A06.

In step 712, the customer is presented with the incentive, which in this example is $5 off the purchase, which is immediately applied to the purchase through the retail vendor's commercial transaction computer and processor, 14A02.

In step 714, the transaction between the customer and retail vendor is completed with the assistance of the retail employee through the retail vendor's commercial transaction computer and processor, 14A02, and the transaction code associated to the retail order and the coupon code representing the incentive of $5 off the purchase, among other data elements pertaining to the order, are generated within the retail vendor's commercial transaction database, 14A04.

In step 716, the transaction between the customer and retail vendor is completed with the assistance of the retail employee through the retail vendor's commercial transaction computer and processor, 14A02, and the transaction code, among other data elements pertaining to the order, are generated within the retail vendor's commercial transaction database, 14A04.

In step 718, the customer, or someone on behalf of the customer, inputs a unique identifier, such as an email address, phone number, or customer identification username/number in the retail vendor's survey and review computer/tablet and processor, 14A14, or with the assistance of the retail employee through the retail vendor's commercial transaction computer and processor, 14A02, and generated in the retail vendor's survey and review database, 14A06.

In step 720, the transaction between the customer and retail vendor is completed with the assistance of the retail employee through the retail vendor's commercial transaction computer and processor, 14A02, and then the unique identifier provided by the customer, along with the associated transaction code to the order, are generated within the retail vendor's survey and review database, 14A06.

In step 722, using the unique identifier provided by the customer, the retail vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the retail vendor (or a third-party acting on behalf of the vendor) other than customer's email address or phone number, then this unique identifier is used to retrieve an email address or phone number associated with the customer for the retail vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 724, upon the customer clicking the URL link, which contains the unique identifier known as the review code or another unique identifier of the like that can be used to associate to the review code, he is directed to the online survey, then completes and submits the review which is sent to the retail vendor's survey and review database, 14A06, along with the review code, or another unique identifier of the like that can be used to associate to the review code which is associated to the original transaction.

In step 726, the retail vendor sends an email message via Internet, 14A10, to the email address or text message via cellular network, 14A08, to the mobile phone, 14A12, associated to the completed review with instructions, which includes a unique identifier known as a coupon code, for the customer to redeem the incentive of $5 off a subsequent purchase.

In step 728, the customer presents the coupon code from the email or text message instructing the customer how to redeem the incentive. The coupon code can either be verbally provided by the customer to the retail vendor and a retail employee can enter the coupon code in the retail vendor's commercial transaction computer and processor, 14A02, or the customer can enter the coupon code into the retail vendor's survey and review computer/tablet and processor, 14A14. Upon verification of the coupon code the incentive of $5 off the purchase is applied, and when the transaction has concluded the coupon code and transaction code associated to the order, among other data elements pertaining to the order, are generated in the retail vendor's commercial transaction database, 14A04.

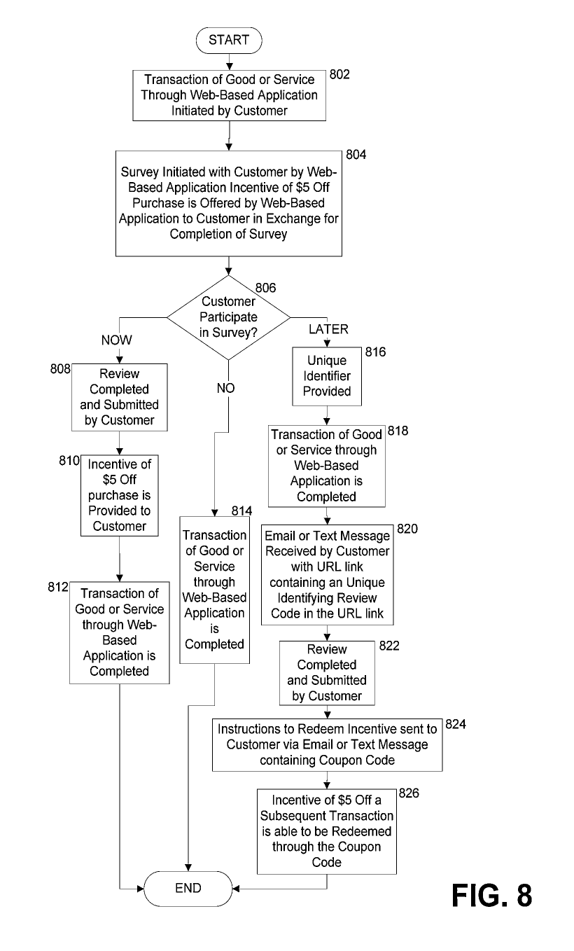

FIG. 8 is a flow chart illustrating the invention as applied to a web-based retail transaction. In one example of the embodiment it includes steps 802, 804, 806, 808, 810 and 812. In another example of the embodiment it includes steps 802, 804, 806 and 814. In another example of the embodiment it includes steps 802, 804, 806, 816, 818, 820, 822, 824 and 826.

In step 802, a customer using his computer/tablet and processor, 14A16, is connected to the Internet, 14A10, and engages in a transaction to purchase goods or services through a vendor's web-based application.

In step 804, the vendor initiates a survey with the customer through the vendor's web-based application during the transaction are displayed through the monitor screen of the customer's computer/tablet and processor, 14A16, words suggesting the customer participate in the survey for an incentive of $5 off a purchase upon completion and submission of the review.

In step 806, the customer is provided the options to participate in the survey at the transaction, participate in the survey after the transaction by clicking a URL link within an email or a text message, or not participate in the survey. The customer's participation decision to the survey can be recorded through the customer's computer/tablet and processor, 14A16, and the data related to the decision regarding participation in the survey is sent to the vendor's commercial transaction, and survey and review database, 14H02, with the assistance of the Internet, 14A10.

In step 808, the customer completes and submits the review through his computer/tablet and processor, 14A16. The customer review, review code and transaction code associated to the order are generated within the vendor's commercial transaction, and survey and review database, 14H02, with the assistance of the Internet, 14A10.

In step 810, the customer is presented with the incentive, which in this example is $5 off the purchase, which is immediately applied to the purchase through the vendor's web-based application that is being accessed by the customer through his computer/tablet and processor, 14A16, that is connected to the Internet, 14A10.

In step 812, the transaction between the customer and vendor is completed through the vendor's web-based application using the customer's computer/tablet and process, 14A16, and the transaction code associated to the order and the coupon code representing the incentive of $5 off the purchase, among other data elements pertaining to the order, are generated within the vendor's commercial transaction, and survey and review database, 14H02.

In step 814, the transaction between the customer and vendor is completed through the vendor's web-based application using the customer's computer/tablet and process, 14A16, and the transaction code associated to the order, among other data elements pertaining to the order, are generated within the vendor's commercial transaction, and survey and review database, 14H02.

In step 816, the customer, or someone on behalf of the customer, inputs a unique identifier, such as an email address, phone number, or customer identification username/number in the vendor's web-based application using the customer's computer/tablet and processor, 14A16, and captured with the assistance of the Internet, 14A10, and generated within the vendor's commercial transaction, and survey and review database, 14H02.

In step 818, the transaction between the customer and vendor is completed through the vendor's web-based application through the customer's computer/tablet and process, 14A16, and the transaction code associated to the order and the coupon code representing the incentive of $5 off a subsequent purchase, among other data elements pertaining to the order, are generated within the vendor's commercial transaction, and survey and review database, 14H02.

In step 820, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 822, upon the customer clicking the URL link, which contains the unique identifier known as the review code or another unique identifier of the like that can be used to associate to the review code, he is directed to the online survey, then completes and submits the review which is sent to the vendor's commercial transaction, and survey and review database, 14H02, along with the review code, or another unique identifier of the like that can be used to associate to the review code which is associated to the original transaction.

In step 824, the vendor sends an email message via Internet, 14A10, to the email address or text message via cellular network, 14A08, to the mobile phone, 14A12, associated to the completed review with instructions, which includes a unique identifier associating the customer review with something known as a coupon code, for the customer to redeem the incentive of $5 off a subsequent purchase.

In step 826, the customer presents the coupon code from the email or text message instructing the customer how to redeem the incentive. The coupon code is provided by the customer through the vendor's web-based application for a subsequent purchase using his computer/tablet and processor, 14A16, with the assistance of the Internet, 14A10. Upon verification of the coupon code the incentive of $5 off of a subsequent purchase is applied to the order, and when the transaction has concluded the coupon code and transaction code associated to the order, among other data elements pertaining to the order, are generated in the vendor's commercial transaction, and survey and review database, 14H02.

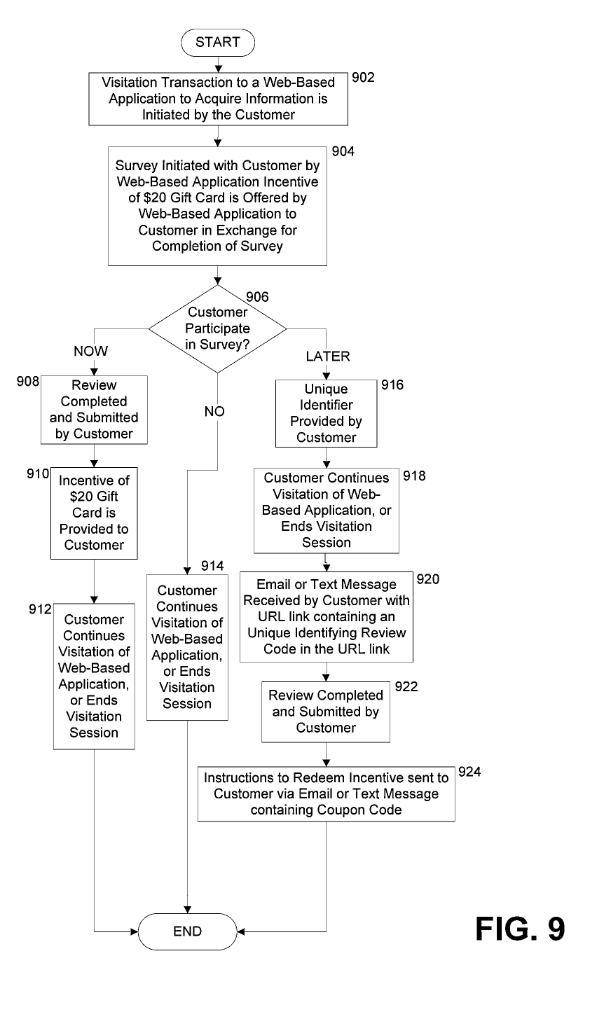

FIG. 9 is a flow chart illustrating the invention as applied to a customer's interaction with a website that does not involve a purchase of goods or services, in accordance with this embodiment. In one example of the embodiment it includes steps 902, 904, 906, 908, 910 and 912. In another example of the embodiment it includes steps 902, 904, 906 and 914. In another example of the embodiment it includes steps 902, 904, 906, 916, 918, 920, 922 and 924.

In step 902, a customer using his computer/tablet and processor, 14A16, is connected to the Internet, 14A10, and visits a vendor's web-based application to acquire information.

In step 904, the vendor initiates a survey with the customer through the vendor's web-based application during the visitation are displayed through the monitor screen of the customer's computer/tablet and processor, 14A16, words suggesting the customer participate in the survey with an incentive of a $20 gift card upon completion and submission of the review.

In step 906, the customer is provided the options to participate in the survey during the web-based application visitation, participate in the survey at another time by clicking a URL link within an email or a text message, or not participate in the survey. The customer's participation decision to the survey can be recorded through the customer's computer/tablet and processor, 14A16, and the data related to the decision regarding participation in the survey is sent to the vendor's commercial transaction, and survey and review database, 14H02, with the assistance of the Internet, 14A10.

In step 908, the customer completes and submits the review through his computer/tablet and processor, 14A16. The customer review, review code and visitation session code associated to the customer's visitation of the vendor's web-based application are generated within the vendor's commercial transaction, and survey and review database, 14H02, with the assistance of the Internet, 14A10.

In step 910, the customer is presented with the incentive, which in this example is a $20 gift card by using a unique coupon code issued by the vendor's commercial transaction, and survey and review database, 14H02, which is immediately emailed to the customer's email addressed, provided by the customer during the survey, via the Internet, 14A10, or text messaged to the customer's mobile phone, provided by the customer during the survey, via the cellular network, 14A08. The $20 gift card is redeemable at an authorized vendor.

In step 912, the customer either continues the visitation session of the vendor's web-based application or ends the visitation session of the vendor's web-based application, of which, these activities along with a coupon code associated with the incentive can be tracked by the vendor through the vendor's commercial transaction, and survey and review database, 14H02.

In step 914, the customer either continues the visitation session of the vendor's web-based application or ends the visitation session of the vendor's web-based application, of which, these activities can be tracked by the vendor through the vendor's commercial transaction, and survey and review database, 14H02.

In step 916, the customer, or someone on behalf of the customer, inputs a unique identifier, such as an email address, phone number, or customer identification username/number in the vendor's web-based application using the customer's computer/tablet and processor, 14A16, and captured with the assistance of the Internet, 14A10, and generated within the vendor's commercial transaction, and survey and review database, 14H02.

In step 918, the customer either continues the visitation session of the vendor's web-based application or ends the visitation session of the vendor's web-based application, of which, these activities can be tracked by the vendor through the vendor's commercial transaction, and survey and review database, 14H02.

In step 920, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 922, upon the customer clicking the URL link, which contains the unique identifier known as the review code or another unique identifier of the like that can be used to associate to the review code, he is directed to the online survey, then completes and submits the review which is sent to the vendor's commercial transaction, and survey and review database, 14H02, along with the review code, or another unique identifier of the like that can be used to associate to the review code which is associated to the original transaction.

In step 924, the customer is presented with the incentive, which in this example is a $20 gift card, by using a unique coupon code issued by the vendor's commercial transaction, and survey and review database, 14H02, which is immediately emailed to the customer's email addressed, provided by the customer during the survey, via the Internet, 14A10, or text messaged to the customer's mobile phone, 14A12, provided by the customer during the survey, via the cellular network, 14A08. The $20 gift card is redeemable at an authorized vendor.

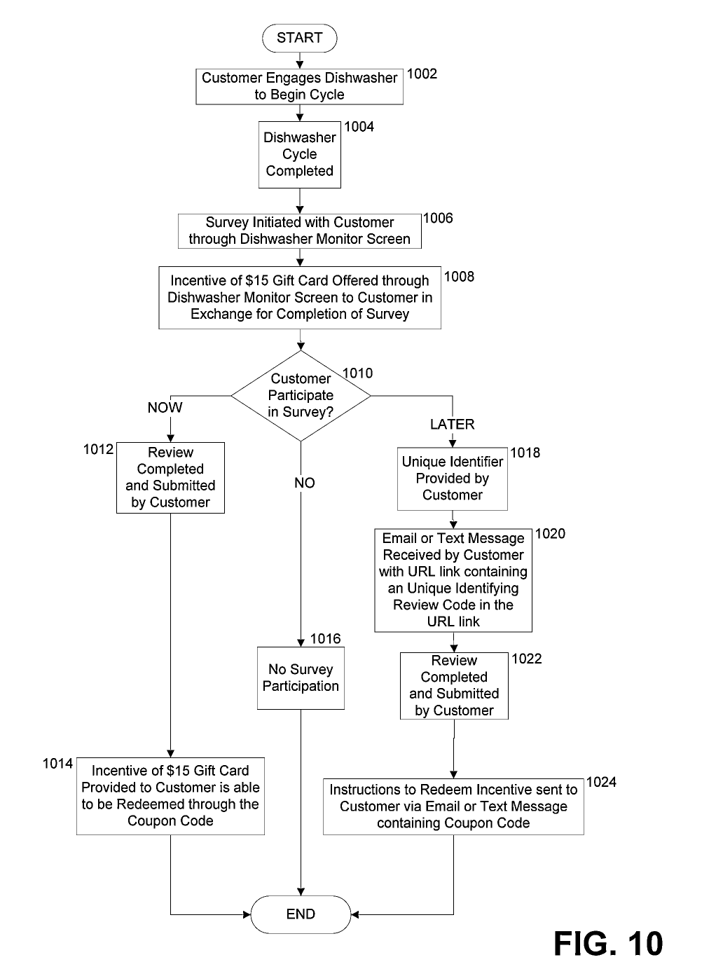

FIG. 10 is a flow chart illustrating the invention applied to a customer interaction with a household appliance (ex. dishwasher machine), in accordance with this embodiment. In one example of the embodiment it includes steps 1002, 1004, 1006, 1008, 1010, 1012 and 1014. In another example of the embodiment it includes steps 1002, 1004, 1006, 1008, 1010 and 1016. In another example of the embodiment it includes steps 1002, 1004, 1006, 1008, 1010, 1018, 1020, 1022 and 1024.

In step 1002, an individual engages in a transaction with a dishwasher machine by beginning its cycle of washing dishes.

In step 1004, the dishwasher machine completes its dishwashing cycle.

In step 1006, the dishwasher machine initiates a survey with the individual through a monitor screen located on the dishwasher machine which is connected to the dishwasher vendor's computer/tablet and processor, and survey and review computer/tablet and processor, 14L02.

In step 1008, the dishwasher machine offers through the vendor's computer/tablet and processor, and survey and review computer/tablet and processor, 14L02, a $15 gift card in exchange for the customer to complete and submit the review.

In step 1010, the customer is provided the options to participate in the survey at the transaction using the monitor on the dishwasher that is connected to the dishwasher vendor's computer/tablet and processor, participate in the survey after the transaction by clicking a URL link within an email or a text message, or not participate in the survey. The customer's participation decision to the survey can be recorded through the customer's computer/tablet and processor, 14A16, and the data related to the decision regarding participation in the survey is sent to the vendor's commercial transaction, and survey and review database, 14H02, with the assistance of the Internet, 14A10.

In step 1012, the customer completes and submits the review through the vendor's computer/tablet and processor, and survey and review computer/tablet and processor, 14L02. The customer review, review code and transaction code associated to the customer's use of the dishwasher are generated within the vendor's commercial transaction, and survey and review database, 14H02, with the assistance of the Internet, 14A10.

In step 1014, the customer is presented with the incentive, which in this example is a $20 gift card by using a unique coupon code issued by the vendor's commercial transaction, and survey and review database, 14H02, which is immediately emailed to the customer's email addressed, provided by the customer during the survey, via the Internet, 14A10, or text messaged to the customer's mobile phone, provided by the customer during the survey, via the cellular network, 14A08. The $15 gift card is redeemable at an authorized vendor.

In step 1016, no participation in the survey by the customer.

In step 1018, the customer, or someone on behalf of the customer, inputs a unique identifier, such as an email address, phone number, or customer identification username/number in the vendor's web-based application using the dishwasher monitor screen connected to the dishwasher vendor's computer/tablet and processor, and survey and review computer/tablet and processor, 14L02, and captured with the assistance of the Internet, 14A10, and generated within the vendor's commercial transaction, and survey and review database, 14H02.

In step 1020, using the unique identifier provided by the customer, the vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the vendor (or a third-party acting on behalf of the vendor) other than customer's email address or phone number, then this unique identifier is used to retrieve an email address or phone number associated with the customer for the vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 1022, upon the customer clicking the URL link, which contains the unique identifier known as the review code or another unique identifier of the like that can be used to associate to the review code, he is directed to the online survey, then completes and submits the review which is sent to the vendor's commercial transaction, and survey and review database, 14H02, along with the review code, or another unique identifier of the like that can be used to associate to the review code which is associated to the original transaction.

In step 1024, the customer is presented with the incentive, which in this example is a $15 gift card, by using a unique coupon code issued by the vendor's commercial transaction, and survey and review database, 14H02, which is immediately emailed to the customer's email addressed, provided by the customer during the survey, via the Internet, 14A10, or text messaged to the customer's mobile phone 14A12, provided by the customer during the survey, via the cellular network, 14A08. The $15 gift card is redeemable at an authorized vendor.

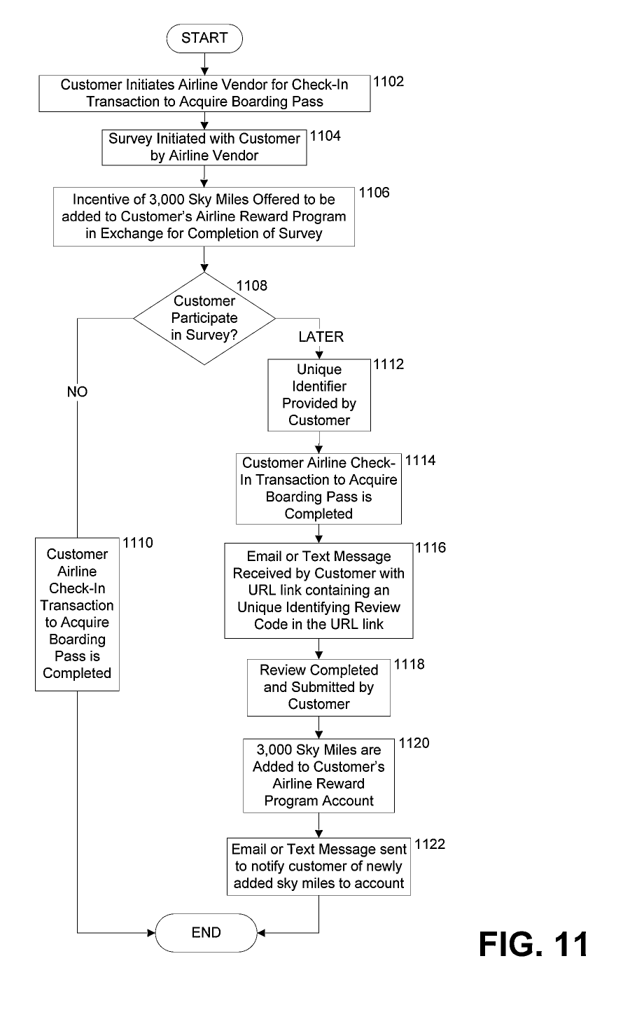

FIG. 11 is a flow chart illustrating the invention's application to an airport airline check-in location. In another example of the embodiment it includes steps 1102, 1104, 1106, 1108 and 1110. In another example of the embodiment it includes steps 1102, 1104, 1106, 1108, 1112, 1114, 1116, 1118, 1120 and 1122.

In step 1102, a customer is at an airport airline check-in location in an attempt to receive an airline boarding pass.

In step 1104, the airline vendor initiates a survey with the customer by either verbally asking the customer to participate in the survey or through the airline vendor's survey and review computer/tablet and processor, 14A14, during the transaction are displayed through the monitor screen words suggesting the customer participate in the survey.

In step 1106, the airline vendor offers an incentive of 3,000 sky miles added to customer's airline reward program account by either verbally notifying the customer of the incentive or through the airline vendor's survey and review computer/tablet and processor, 14A14, during the transaction are displayed through the monitor screen words notifying the customer of the incentive in exchange for the customer's completion of the survey.

In step 1108, the customer is provided the option, either verbally from the airline vendor or through the airline vendor's survey and review computer/tablet, 14A14, to participate in the survey at the transaction, participate in the survey after the transaction by clicking a URL link within an email or a text message, or not participate in the survey. The customer's participation decision to the survey can be recorded either by the airline employee through the airline vendor's commercial transaction computer and processor, 14A02, or entered by the customer through the airline vendor's survey and review computer/tablet and processor, 14A14. The data related to the customer's decision to, or not to, participate in the survey is sent to the airline vendor's survey and review database, 14A06.

In step 1110, the airline check-in process between the airline vendor and customer is completed.

In step 1112, the customer, or someone on behalf of the customer, inputs a unique identifier, such as an email address, phone number, or customer identification username/number in the airline vendor's survey and review computer/tablet and processor, 14A14, or with the assistance of the airline employee through the airline vendor's commercial transaction computer and processor, 14A02, and generated in the airline vendor's survey and review database, 14A06.

In step 1114, the transaction between the customer and airline vendor is completed with the assistance of the airline employee through the airline vendor's commercial transaction computer and processor, 14A02, and then the unique identifier provided by the customer, along with the associated transaction code to the check-in process, are generated within the airline vendor's survey and review database, 14A06.

In step 1116, using the unique identifier provided by the customer, the airline vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the airline vendor (or a third-party acting on behalf of the vendor) other than customer's email address or phone number, then this unique identifier is used to retrieve an email address or phone number associated with the customer for the airline vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 1118, upon the customer clicking the URL link, which contains the unique identifier known as the review code or another unique identifier of the like that can be used to associate to the review code, he is directed to the online survey, then completes and submits the review which is sent to the airline vendor's survey and review database, 14A06, along with the review code, or another unique identifier of the like that can be used to associate to the review code which is associated to the original airline boarding pass check-in transaction.

In step 1120, the airline vendor receives the completed review and then the airline vendor adds 3,000 sky miles immediately to the customer's airline reward program account.

In step 1122, the airline vendor sends an email message to the email address or text message to the phone number associated to the completed review notifying the customer of the 3,000 sky miles added to customer's airline reward program account in exchange for the completion and submission of the review pertaining to the airline boarding pass check-in transaction.

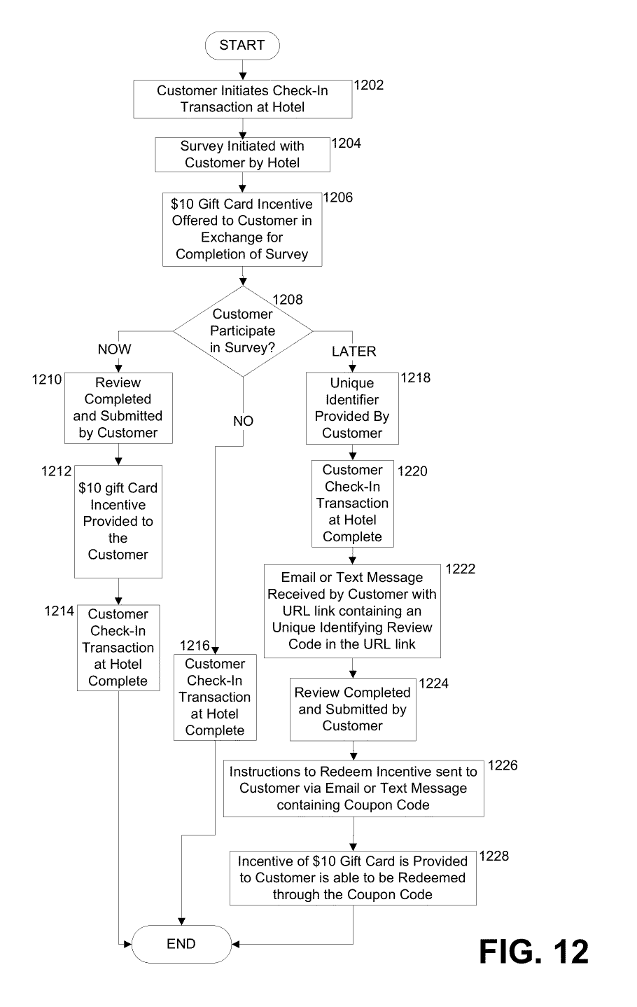

FIG. 12 is a flow chart illustrating the application of the invention to the check-in process at a hotel's physical establishment. In one example of the embodiment it includes steps 1202, 1204, 1206, 1208, 1210, 1212 and 1214. In another example of the embodiment it includes steps 1202, 1204, 1206, 1208 and 1216. In another example of the embodiment it includes steps 1202, 1204, 1206, 1208, 1218, 1220, 1222, 1224, 1226 and 1228.

In step 1202, a customer engages in a transaction with a hotel vendor to check-in to the hotel at the hotel vendor's physical establishment with the assistance of a hotel employee through the hotel vendor's commercial transaction computer and processor, 14A02.

In step 1204, the hotel vendor initiates a survey with the customer by either verbally asking the customer to participate in the survey or through the hotel vendor's survey and review computer/tablet and processor, 14A14, during the transaction are displayed through the monitor screen words suggesting the customer to participate in the survey.

In step 1206, the movie theater vendor offers an incentive of a $10 gift card either verbally notifying the customer of the incentive or through the movie theater vendor's survey and review computer/tablet and processor, 14A14, during the transaction are displayed through the monitor screen words notifying the customer of the incentive in exchange for the customer's completion and submission of the review.

In step 1208, the customer is provided the option, either verbally from the hotel vendor or through the hotel vendor's survey and review computer/tablet, 14A14, to participate in the survey at the transaction, participate in the survey after the transaction by clicking a URL link within an email or a text message, or not participate in the survey. The customer's participation decision to the survey can be recorded either by the hotel employee through the hotel vendor's commercial transaction computer and processor, 14A02, or entered by the customer through the hotel vendor's survey and review computer/tablet and processor, 14A14. The data related to the customer's decision to, or not to, participate in the survey is sent to the hotel vendor's survey and review database, 14A06.

In step 1210, the customer completes and submits the review through the hotel vendor's survey and review computer/tablet and processor, 14A14. The customer review, review code and transaction code associated to the hotel check-in are generated within the hotel vendor's survey and review database, 14A06.

In step 1212, the customer is presented with a physical $10 gift card or presented through an email via Internet, 14A10, to the customer's email address, or through text message via cellular network, 14A08, to the customer's mobile phone, 14A12, is the incentive of a $10 gift card and the associated coupon code which is redeemable through an authorized vendor.

In step 1214, the transaction between the customer and hotel vendor is completed with the assistance of a hotel employee through the hotel vendor's commercial transaction computer and processor, 14A02, and the transaction code and coupon code associated to the incentive, among other data elements pertaining to the hotel check-in, are generated within the hotel vendor's commercial transaction database, 14A04.

In step 1216, the transaction between the customer and hotel vendor is completed with the assistance of the hotel employee through the hotel vendor's commercial transaction computer and processor, 14A02, and the transaction code, among other data elements pertaining to the hotel check-in, are generated within the hotel vendor's commercial transaction database, 14A04.

In step 1218, the customer, or someone on behalf of the customer, inputs a unique identifier, such as an email address, phone number, or customer identification username/number in the hotel vendor's survey and review computer/tablet and processor, 14A14, or with the assistance of the hotel employee through the hotel vendor's commercial transaction computer and processor, 14A02, and generated in the hotel vendor's survey and review database, 14A06.

In step 1220, the transaction between the customer and hotel vendor is completed with the assistance of a hotel employee through the hotel vendor's commercial transaction computer and processor, 14A02, and the transaction code, among other data elements pertaining to the hotel check-in, are generated within the hotel vendor's commercial transaction database, 14A04.

In step 1222, using the unique identifier provided by the customer, the hotel vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the hotel vendor (or a third-party acting on behalf of the vendor) other than customer's email address or phone number, then this unique identifier is used to retrieve an email address or phone number associated with the customer for the hotel vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the hotel check-in transaction the review will be applied.

In step 1224, upon the customer clicking the URL link, which contains the unique identifier known as the review code or another unique identifier of the like that can be used to associate to the review code, he is directed to the online survey, then completes and submits the review which is sent to the hotel vendor's survey and review database, 14A06, along with the review code, or another unique identifier of the like that can be used to associate to the review code which is associated to the original transaction.

In step 1226, the hotel vendor sends an email message via Internet, 14A10, to the email address or text message via cellular network, 14A08, to the mobile phone, 14A12, associated to the completed review with instructions, which includes a unique identifier known as a coupon code, for the customer to redeem the incentive of a $10 gift card.

In step 1228, the customer is presented with the incentive, which in this example is a $10 gift card by using a unique coupon code issued by the hotel vendor's survey and review database, 14A06, which is immediately emailed to the customer's email addressed, provided by the customer during the survey, via the Internet, 14A10, or text messaged to the customer's mobile phone, 14A12, provided by the customer during the survey, via the cellular network, 14A08. The $15 gift card is redeemable at an authorized vendor.

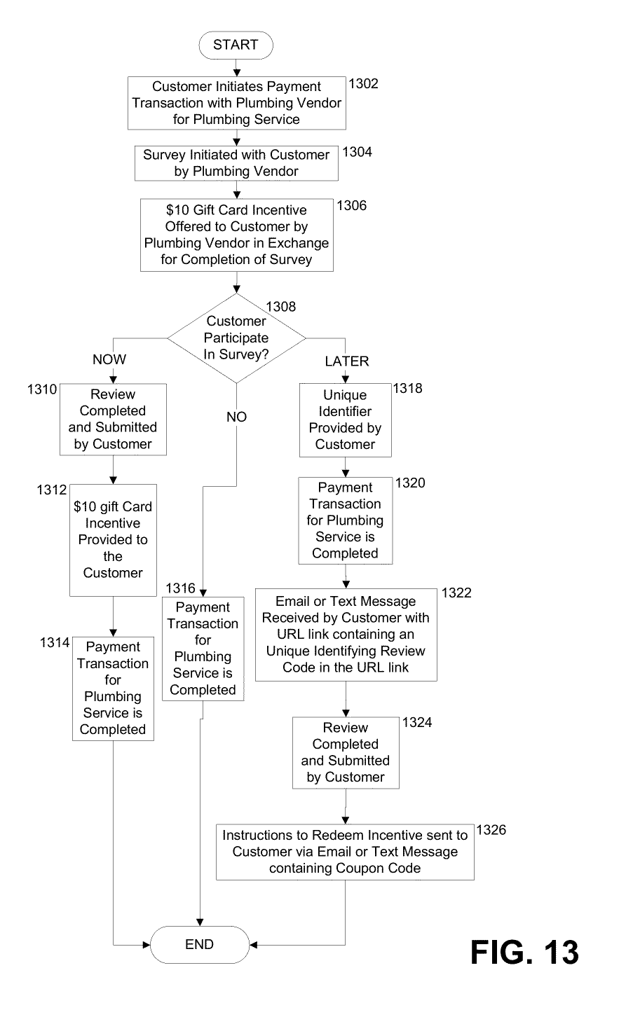

FIG. 13 is a flow chart illustrating application of the invention to a household service transaction, namely, plumbing services. In one example of the embodiment it includes steps 1302, 1304, 1306, 1308, 1310, 1312 and 1314. In another example of the embodiment it includes steps 1302, 1304, 1306, 1308 and 1316. In another example of the embodiment it includes steps 1302, 1304, 1306, 1308, 1318, 1320, 1322, 1324 and 1326.

In step 1302, a customer initiates the payment transaction process for plumbing services through the plumbing vendor's computer/tablet and processor, and survey and review computer/tablet and processor, 14L02.

In step 1304, the plumbing vendor initiates a survey with the customer by either verbally asking the customer to participate in the survey or through the plumbing vendor's computer/tablet and processor, and survey and review computer/tablet and processor, 14L02, during the transaction are displayed through the monitor screen words suggesting the customer to participate in the survey.

In step 1306, the plumbing vendor offers an incentive, such as a $10 gift card, either verbally notifying the customer of the incentive or through the plumbing vendor's computer/tablet and processor, and survey and review computer/tablet and processor, 14L02, during the transaction are displayed through the monitor screen words notifying the customer of the incentive in exchange for the customer's completion and submission of the review.

In step 1308, the customer is provided the option, either verbally from the plumbing vendor's computer/tablet and processor, and survey and review computer/tablet and processor, 14L02, to participate in the survey at the transaction, participate in the survey after the transaction by clicking a URL link within an email or a text message, or not participate in the survey. The customer's participation decision to the survey can be recorded either by the plumbing employee or the customer using the vendor's computer/tablet and processor, and survey and review computer/tablet and processor, 14L02. The data related to the customer's decision to, or not to, participate in the survey is sent to the plumbing vendor's commercial transaction, and survey and review database, 14H02.

In step 1310, the customer completes and submits the review through the plumbing vendor's computer/tablet and processor, and survey and review computer/tablet and processor, 14L02. The customer review, review code and transaction code associated to the order are generated within the plumbing vendor's commercial transaction, and survey and review database, 14H02.

In step 1312, the customer is presented with a physical $10 gift card or presented through an email via Internet, 14A10, to the customer's email address, or through text message via cellular network, 14A08, to the customer's mobile phone, 14A12, is the incentive of a $10 gift card and the associated coupon code which is redeemable through an authorized vendor.

In step 1314, the transaction between the customer and hotel vendor is completed with the assistance of a plumbing employee through the plumbing vendor's computer/tablet and processor, and survey and review computer/tablet and processor, 14L02, and the transaction code associated to the plumbing service and coupon code associated to the incentive, among other data elements pertaining to the plumbing service, are generated within the plumbing vendor's commercial transaction, and survey and review database, 14H02.

In step 1316, the transaction between the customer and hotel vendor is completed with the assistance of a plumbing employee through the plumbing vendor's computer/tablet and processor, and survey and review computer/tablet and processor, 14L02, and the transaction code associated to the plumbing service, among other data elements pertaining to the plumbing service, are generated within the plumbing vendor's commercial transaction, and survey and review database, 14H02.

In step 1318, the customer, or someone on behalf of the customer, inputs a unique identifier, such as an email address, phone number, or customer identification username/number in the plumbing vendor's computer/tablet and processor, and survey and review computer/tablet and processor, 14L02, and generated in the plumbing vendor's commercial transaction, and survey and review database, 14H02.

In step 1320, the transaction between the customer and plumbing vendor is completed through the plumbing vendor's computer/tablet and processor, and survey and review computer/tablet and processor, 14L02, and then the unique identifier provided by the customer, along with the associated transaction code to the order, are generated within the plumbing vendor's commercial transaction, and survey and review database, 14H02.

In step 1322, using the unique identifier provided by the customer, the plumbing vendor sends an email via Internet, 14A10, to the customer's email address or a text message via cellular network, 14A08, to the customer's mobile phone, 14A12. This message contains instructions for participating in the survey and a URL link containing the unique identifier associated to the transaction that the review will be applied. In the event that a unique identifier is provided by the customer to the plumbing vendor (or a third-party acting on behalf of the vendor) other than customer's email address or phone number, then this unique identifier is used to retrieve an email address or phone number associated with the customer for the plumbing vendor, to send an email via Internet, 14A10, to the customer's email address or a text message via cellular network, 14A08, to the customer's mobile phone, 14A12, within the contents of the message are instructions for participating in the survey and a URL link containing the unique identifier associated to the transaction that the review will be applied.

In step 1324, upon the customer clicking the URL link, which contains the unique identifier known as the review code or another unique identifier of the like that can be used to associate to the review code, he is directed to the online survey, then completes and submits the review which is sent to the plumbing vendor's commercial transaction, and survey and review database, 14H02, along with the review code, or another unique identifier of the like that can be used to associate to the review code which is associated to the original transaction.

In step 1326, the plumbing vendor sends an email message via Internet, 14A10, to the email address or text message via cellular network, 14A08, to the mobile phone, 14A12, associated to the completed review with instructions, which includes a unique identifier associating the customer review with something known as a coupon code to associate to the incentive of a $10 gift card. The $10 gift card is redeemable at an authorized vendor.

Thus, several advantages exist by initiating the survey with the customer of one or more aspects are that processing of review data is reliable and trustworthy. Another advantage of one or more aspects are that the processing of review data is broadly relevant, to cover all products/services and other review data deemed worthy by a vendor. Another advantage of one or more aspects is that the processing of review data is highly accurate. Another advantage of one or more aspects is that the initiation of the survey with the customer generates a higher participation rate. Another advantage of one or more aspects is that the processing of review data is accessible in a useable format, in a timely manner. These and other advantages of one or more aspects will become apparent from a consideration of the foregoing description and the accompanying drawings.

Other features and advantages of the present embodiment will become apparent to those skilled in the art from the following detailed description. It is to be understood, however, that the detailed description and specific examples, while indicating preferred embodiments of the present embodiment, are given by way of illustration and not limitation. Many changes and modifications within the scope of the embodiments disclosed herein may be made without departing from the spirit thereof, and such embodiments include all such modifications.

What is claimed is:

1. A method of collecting customer feedback regarding a specific transaction contemporaneously with the transaction, comprising the steps of:
Assigning one or more review codes to a specific transaction at the point of sale using a processor, wherein each review code is uniquely associated with a survey regarding said transaction;
Providing a point of sale data entry interface allowing a customer to respond to one or more surveys regarding said transaction prior to completion of said transaction;
Storing customer answers in response to said one or more surveys in a vendor database;
Associating said customer answers to a particular survey with said review code associated with said particular survey using said processor;
Assigning one or more coupon codes to each said review code using a processor; and
Issuing said customer via said point of sale data entry interface an incentive uniquely associated with said coupon code upon customer's completion of said survey.

2. The method according to claim 1, wherein said incentive is immediately redeemable at the point of sale.

3. A method of collecting customer feedback regarding a specific transaction, comprising the steps of:
Assigning one or more review codes to a specific transaction at the point of sale using a processor, wherein each said review code is uniquely associated with a survey about a particular aspect of said transaction;
Providing a point of sale entry interface to a vendor database allowing a customer to enter contact information contemporaneously with said transaction;
Storing said contact information in said vendor database;
Transmitting to a customer data entry interface remote from said point of sale entry interface after completion of said transaction a message comprising a link to one or more surveys regarding said transaction, wherein said link associates said review codes and said contact information, and wherein said link permits said customer to respond to said one or more surveys from said customer data entry interface;
Storing customer responses to said one or more surveys in said vendor database;
Associating said customer responses to a particular survey with the review code associated with that particular survey and with said customer information using a processor;
Assigning one or more coupon codes to each said review code using a processor; and
Transmitting to said customer data entry interface one or more incentives uniquely associated with one or more coupon codes upon customer's completion of said survey.

4. A system for collecting customer survey data regarding a specific transaction, comprising:
A first data entry interface linked to a vendor point of sale system which transmits information regarding a specific transaction by a customer to a database;
A database linked to said first data entry interface which stores said information regarding a specific transaction by a customer, a customer survey containing questions relating to a specific transaction, and answers to said customer survey;
A processor linked to said database that associates said information regarding a specific transaction by a customer with a first unique identifier; and associates a second unique identifier said answers to said customer survey;

5. The system according to claim 4, wherein said first data entry interface allows the entry of customer contact information; said database additionally stores said customer contact information; and said processor associates customer contact information with a third unique identifier

6. The system according to claim 5, further comprising a second data entry interface that is remote from the vendor point of sale system permitting said customer to submit answers to said customer survey questions, wherein said processor generates a link to said database containing said first unique identifiers and said third unique identifiers, transmits said link to said second data entry interface, and transmits an incentive to said second data entry interface once said answers have been received by said database.

7. The system according to claim 4, wherein said first data entry interface allows said customer to answer survey questions contemporaneously with a specific transaction; and
said processor transmits an incentive to said first data entry interface.

8. The system according to claim 7, wherein said incentive may be applied to said specific transaction.
